(19) United States
(12) Patent Application Publication
(10) Pub. No.: US 2026/0079413 A1
(43) Pub. Date: Mar. 19, 2026

(54) ELECTROPHOTOGRAPHIC PHOTORECEPTOR, PROCESS CARTRIDGE, AND IMAGE FORMING APPARATUS

(71) Applicant: FUJIFILM Business Innovation Corp., Tokyo (JP)

(72) Inventors: Yuki OYAMADA, Kanagawa (JP); Masahiro IWASAKI, Kanagawa (JP); Kenta IDE, Kanagawa (JP)

(73) Assignee: FUJIFILM Business Innovation Corp., Tokyo (JP)

(21) Appl. No.: 19/056,670

(22) Filed: Feb. 18, 2025

(30) Foreign Application Priority Data
Sep. 19, 2024 (JP) 2024-162551

(51) Int. Cl. G03G 5/047; G03G 5/05

(52) U.S. Cl. CPC G03G 5/047; G03G 5/05; G03G 2215/00957; G03G 2215/00962; G03G 2221/183

(57) ABSTRACT

An electrophotographic photoreceptor includes a conductive substrate, an undercoat layer that is provided on the conductive substrate and contains an electron transport material and a binder resin, a charge generation layer that is provided on the undercoat layer, and a charge transport layer that is provided on the charge generation layer, in which, in the undercoat layer, a ratio (X1/X2) of a content X1 (% by mass) of the electron transport material in a region within 4% in a thickness direction of the undercoat layer from an interface between the undercoat layer and the charge generation layer to a content X2 (% by mass) of the electron transport material in a region exceeding 4% in the thickness direction of the undercoat layer from the interface between the undercoat layer and the charge generation layer is 0 or 78 or less.

### CROSS-REFERENCE TO RELATED APPLICATIONS

This application is based on and claims priority under 35 USC 119 from Japanese Patent Application No. 2024-162551 filed Sep. 19, 2024.

### BACKGROUND

### (i) Technical Field

The present invention relates an electrophotographic photoreceptor, a process cartridge, and an image forming apparatus.

### (ii) Related Art

JP1995-175250A discloses “function separation-type photoreceptor for electrophotography, in which a charge generation layer (CGL) and a charge transport layer (CTL) containing a donor compound having hole transportability are sequentially laminated on a conductive substrate, where an undercoat layer containing a phthalimide compound is provided between the conductive substrate and the CGL”.

JP1995-175251A discloses “function separation-type photoreceptor for electrophotography, in which a charge generation layer (CGL) and a charge transport layer (CTL) containing a donor compound having hole transportability are sequentially laminated on a conductive substrate, where an undercoat layer containing a pyrazine compound is provided between the conductive substrate and the CGL”.

JP1995-175252A discloses “function separation-type photoreceptor for electrophotography, in which a charge generation layer (CGL) and a charge transport layer (CTL) containing a donor compound having hole transportability are sequentially laminated on a conductive substrate, where an undercoat layer containing an oxazole compound or a thiazole compound is provided between the conductive substrate and the CGL”.

JP2023-130151A discloses “electrophotographic photoreceptor including, on a conductive support, an undercoat layer and a photosensitive layer, in which the undercoat layer contains crystalline electron-transporting compound particles, a half-width of a maximum intensity peak in an X-ray diffraction measurement of the undercoat layer measured in a thickness direction is 5° or less, and in a case where a relative integral intensity of each peak in the X-ray diffraction measurement of the undercoat layer measured in the thickness direction is denoted by I1 and a relative integral intensity of each peak in the X-ray diffraction measurement of the undercoat layer in a powder state having a volume-average particle diameter of 5 μm or less is denoted by I2, a value of a maximum value Nmax in an alignment index N represented by a specific expression is 1 or more and 3 or less”.

### SUMMARY

In an electrophotographic photoreceptor mounted on an image forming apparatus, an undercoat layer is provided on a conductive substrate. In an undercoat layer of the recent years, an organic compound having electron transport performance (hereinafter, referred to as an electron transport material) is employed as a substitute for a metal oxide from the viewpoint of environmentally low-impact manufacturing. However, in a case where an electrophotographic photoreceptor including the undercoat layer containing the electron transport material is operated for a long period of time in a high-temperature and high-humidity environment, charge retention property tends to be deteriorated. Therefore, aspects of non-limiting embodiments of the present disclosure relate to an electrophotographic photoreceptor having excellent charge retention property even in a case of being operated for a long period of time in a high-temperature and high-humidity environment (for example, performing a cycle of charging and exposure of the electrophotographic photoreceptor at 30° C. and 80% RH 10,000 times), as compared with a case where a ratio (X1/X2) of contents is more than 78 or a ratio (Y1/Y2) of area ratios is more than 81.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific methods for achieving the above-described object include the following. Each formula is the same as the formula having the same number described later.

According to an aspect of the present disclosure, there is provided an electrophotographic photoreceptor including:
a conductive substrate;
an undercoat layer that is provided on the conductive substrate and contains an electron transport material and a binder resin;
a charge generation layer that is provided on the undercoat layer; and
a charge transport layer that is provided on the charge generation layer,
in which, in the undercoat layer, a ratio (X1/X2) of a content X1(% by mass) of the electron transport material in a region within 4% in a thickness direction of the undercoat layer from an interface between the undercoat layer and the charge generation layer to a content X2(% by mass) of the electron transport material in a region exceeding 4% in the thickness direction of the undercoat layer from the interface between the undercoat layer and the charge generation layer is 0 or 78 or less.

### BRIEF DESCRIPTION OF THE DRAWINGS

Exemplary embodiment(s) of the present invention will be described in detail based on the following figures, wherein:

FIG. 1 is a partial cross-sectional view showing an example of a layer configuration of an electrophotographic photoreceptor according to the present exemplary embodiment;

FIG. 2 is a view schematically showing the configuration of an example of an image forming apparatus according to the present exemplary embodiment; and

FIG. 3 is a view schematically showing a configuration of another example of the image forming apparatus according to the present exemplary embodiment.

### DETAILED DESCRIPTION

The exemplary embodiments of the present disclosure will be described below. The following descriptions and examples merely illustrate the exemplary embodiments, and do not limit the scope of the exemplary embodiments.

In the present disclosure, a numerical range described using “to” represents a range including numerical values listed before and after “to” as the minimum value and the maximum value respectively.

Regarding the numerical ranges described in stages in the present disclosure, the upper limit or lower limit of a numerical range may be replaced with the upper limit or lower limit of another numerical range described in stages. Furthermore, in the present disclosure, the upper limit or lower limit of a numerical range may be replaced with values described in examples.

In the present disclosure, the term “step” includes not only an independent step but a step that is not clearly distinguished from other steps as long as the purpose of the step is achieved.

In the present disclosure, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present disclosure, each component may include a plurality of corresponding substances. In a case where the amount of each component in a composition is mentioned in the present disclosure, and there are two or more kinds of substances corresponding to each component in the composition, unless otherwise specified, the amount of each component means the total amount of two or more kinds of the substances present in the composition.

In the present disclosure, each component may include two or more kinds of corresponding particles. In a case where there are two or more kinds of particles corresponding to each component in a composition, unless otherwise specified, the particle size of each component means a value for a mixture of two or more kinds of the particles present in the composition.

In the present disclosure, an alkyl group and an alkylene group are any of linear, branched, or cyclic, unless otherwise specified.

In the present disclosure, a hydrogen atom in an organic group, an aromatic ring, a linking group, an alkyl group, an alkylene group, an aryl group, an aralkyl group, an alkoxy group, an aryloxy group, and the like may be substituted with a halogen atom.

In the present disclosure, in a case where a compound is represented by a structural formula, the compound may be represented by a structural formula in which symbols representing a carbon atom and a hydrogen atom (C and H) in a hydrocarbon group and/or a hydrocarbon chain are omitted.

In the present disclosure, “constitutional unit” of a copolymer or a resin is the same as a monomer unit.

### Electrophotographic Photoreceptor

Hereinafter, an electrophotographic photoreceptor will be simply referred to as “photoreceptor”.

Hereinafter, in a case where common matters between a first exemplary embodiment and a second exemplary embodiment are described, the exemplary embodiments will be referred to as “present exemplary embodiment”.

Hereinafter, a compound represented by Formula (P) is also referred to as perylenetetracarboxylic acid dianhydride.

A photoreceptor according to a first exemplary embodiment includes a conductive substrate, an undercoat layer that is provided on the conductive substrate and contains an electron transport material and a binder resin, a charge generation layer that is provided on the undercoat layer, and a charge transport layer that is provided on the charge generation layer, in which, in the undercoat layer, a ratio (X1/X2) of a content X1(% by mass) of the electron transport material in a region within 4% in a thickness direction of the undercoat layer from an interface between the undercoat layer and the charge generation layer to a content X2(% by mass) of the electron transport material in a region exceeding 4% in the thickness direction of the undercoat layer from the interface between the undercoat layer and the charge generation layer is 0 or 78 or less.

A photoreceptor according to a second exemplary embodiment includes a conductive substrate, an undercoat layer that is provided on the conductive substrate and contains an electron transport material and a binder resin, a charge generation layer that is provided on the undercoat layer, and a charge transport layer that is provided on the charge generation layer, in which, in a cross section in a thickness direction of the undercoat layer, a ratio (Y1/Y2) of an area ratio Y1(%) of the electron transport material in a region within 4% in the thickness direction of the undercoat layer from an interface between the undercoat layer and the charge generation layer to an area ratio Y2(%) of the electron transport material in a region exceeding 4% in the thickness direction of the undercoat layer from the interface between the undercoat layer and the charge generation layer is 0 or 81 or less.

In an electrophotographic photoreceptor mounted on an image forming apparatus, an undercoat layer is provided on a conductive substrate. In an undercoat layer of the recent years, an electron transport material is employed as a substitute for a metal oxide from the viewpoint of environmentally low-impact manufacturing. However, in a case where an electrophotographic photoreceptor including the undercoat layer containing the electron transport material is operated for a long period of time in a high-temperature and high-humidity environment (for example, performing a cycle of charging and exposure of the electrophotographic photoreceptor at 30° C. and 80% RH 10,000 times), the charge generation layer may be electrochemically corroded by a factor such as a radical derived from the electron transport material contained in the undercoat layer. As a result, electron transport properties are reduced in the corrosion region, and the charge retention property tends to be reduced.

On the other hand, the electrophotographic photoreceptor according to the present exemplary embodiment has the above-described configuration, and thus has excellent charge retention property even in a case of being operated for a long period of time in a high-temperature and high-humidity environment. The mechanism is not necessarily clear, but is presumed as follows.

In the undercoat layer according to the first exemplary embodiment, the ratio (X1/X2) of the content X1(% by mass) of the electron transport material in the region within 4% in the thickness direction of the undercoat layer from the interface between the undercoat layer and the charge generation layer to the content X2(% by mass) of the electron transport material in the region exceeding 4% in the thickness direction of the undercoat layer from the interface between the undercoat layer and the charge generation layer is 0 or 78 or less.

In the cross section in the thickness direction of the undercoat layer according to the second exemplary embodiment, the ratio (Y1/Y2) of the area ratio Y1(%) of the electron transport material in the region within 4% in the thickness direction of the undercoat layer from an interface between the undercoat layer and the charge generation layer to the area ratio Y2(%) of the electron transport material in the region exceeding 4% in the thickness direction of the undercoat layer from the interface between the undercoat layer and the charge generation layer is 0 or 81 or less.

That is, the undercoat layer according to the present exemplary embodiment has a configuration in which the content of the electron transport material is small on the interface side between the undercoat layer and the charge generation layer, or the electron transport material is not contained on the interface side between the undercoat layer and the charge generation layer. Therefore, infiltration of moisture that has infiltrated from the surface layer side into the undercoat layer is suppressed. As a result, even in a case of long-term operation in a high-temperature and high-humidity environment, the electron transport material contained in the undercoat layer is suppressed from being electrochemically corroded by the moisture, and the charge retention property is excellent.

Hereinafter, a layer configuration of the photoreceptor according to the present exemplary embodiment will be described with reference to the drawing.

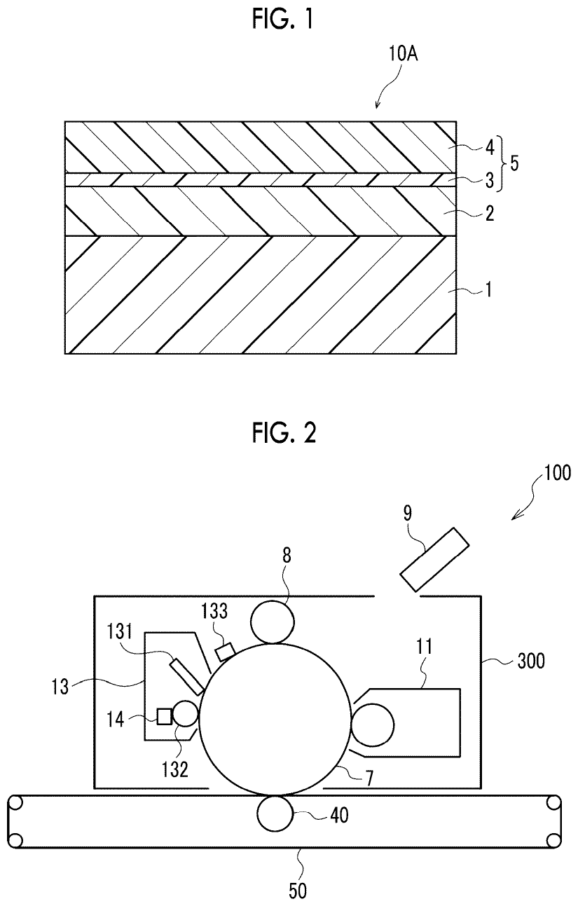

FIG. 1 is a partial cross-sectional view schematically showing an example of a layer configuration of the photoreceptor according to the present exemplary embodiment. A photoreceptor 10A shown in FIG. 1 includes a lamination-type photosensitive layer. The photoreceptor 10A has a structure in which an undercoat layer 2, a charge generation layer 3, and a charge transport layer 4 are laminated in this order on a conductive substrate 1, and the charge generation layer 3 and the charge transport layer 4 constitute a photosensitive layer 5 (so-called function separation-type photosensitive layer). The photoreceptor 10A may include an interlayer (not shown) between the undercoat layer 2 and the charge generation layer 3.

Hereinafter, each layer of the electrophotographic photoreceptor according to the present exemplary embodiment will be described in detail. The reference numerals will not be provided.

### Undercoat Layer

The undercoat layer contains an electron transport material and a binder resin. The undercoat layer may further contain other materials in addition to the electron transport material and the binder resin, as necessary.

### Content Ratio

In the undercoat layer according to the first exemplary embodiment, the ratio (X1/X2) of the content X1(% by mass) of the electron transport material in the region within 4% in the thickness direction of the undercoat layer from the interface between the undercoat layer and the charge generation layer to the content X2(% by mass) of the electron transport material in the region exceeding 4% in the thickness direction of the undercoat layer from the interface between the undercoat layer and the charge generation layer is 0 or 78 or less, for example, preferably 0 or 74 or less, and more preferably 0 or 72 or less.

In the undercoat layer according to the second exemplary embodiment, the ratio (X1/X2) of the content X1(% by mass) of the electron transport material in the region within 4% in the thickness direction of the undercoat layer from the interface between the undercoat layer and the charge generation layer to the content X2(% by mass) of the electron transport material in the region exceeding 4% in the thickness direction of the undercoat layer from the interface between the undercoat layer and the charge generation layer is 0 or 78 or less, for example, preferably 0 or 74 or less, and more preferably 0 or 72 or less.

In a case where the ratio (X1/X2) is 0 or 78 or less, the content of the electron transport material is small on the interface side between the undercoat layer and the charge generation layer, or the electron transport material is not contained on the interface side between the undercoat layer and the charge generation layer. Therefore, the infiltration of the electron transport material contained in the undercoat layer into the charge generation layer is further suppressed. As a result, the infiltration of moisture that has infiltrated from the surface layer side into the undercoat layer is suppressed. Accordingly, even in a case of long-term operation in a high-temperature and high-humidity environment, the electron transport material contained in the undercoat layer is suppressed from being electrochemically corroded, and thus the charge retention property is excellent.

In the undercoat layer, the content X1 of the electron transport material in the region within 4% in the thickness direction of the undercoat layer from the interface between the undercoat layer and the charge generation layer is, for example, preferably 0% by mass or 55% by mass or less, more preferably 0% by mass or 53% by mass or less, and still more preferably 0% by mass or 50% by mass or less.

In a case where the X1 is 0% by mass or 55% by mass or less, the content of the electron transport material is small on the interface side between the undercoat layer and the charge generation layer, or the electron transport material is not contained on the interface side between the undercoat layer and the charge generation layer. Therefore, infiltration of moisture that has infiltrated from the surface layer side into the undercoat layer is suppressed. Accordingly, even in a case of long-term operation in a high-temperature and high-humidity environment, the electron transport material contained in the undercoat layer is suppressed from being electrochemically corroded, and thus the charge retention property is excellent.

In the undercoat layer, the content X2 of the electron transport material in the region exceeding 4% in the thickness direction of the undercoat layer from the interface between the undercoat layer and the charge generation layer is, for example, preferably 60% by mass or more and 80% by mass or less, more preferably 60% by mass or more and 75% by mass or less, and still more preferably 65% by mass or more and 72% by mass or less.

In a case where the X2 is 60% by mass or more, the electron transport material in the undercoat layer is sufficiently close to each other, and thus the electron transport performance is excellent. In a case where the X2 is 80% by mass or less, aggregation of particles in the undercoat layer is suppressed, that is excellent in terms of electrical properties and mechanical strength.

A method of setting the above-described X1, X2, and ratio (X1/X2) to the above-described ranges is not particularly limited, and examples thereof include a method of preparing two kinds of coating solutions for forming an undercoat layer, in which the concentration of the electron transport material is different from each other, and forming a coating film so that the concentration of the electron transport material on the interface side with the charge generation layer is reduced; and a method of thinly coating the interface side of the undercoat layer with the charge generation layer with a resin layer not containing the electron transport material.

A method of confirming the above-described X1, X2, and ratio (X1/X2) is as follows.

The electrophotographic photoreceptor is cut together with the base material in the thickness direction to obtain a test piece. The test piece is analyzed by time-of-flight secondary ion mass spectrometry (TOF-SIMS). For quantification of the electron transport material, for example, a signal having a molecular weight of 800 or less is regarded as being derived from the electron transport material, and a proportion of the signal in the entire area is calculated.

The content X1 of the electron transport material in the region within 4% in the thickness direction of the undercoat layer from the interface between the undercoat layer and the charge generation layer and the content X2 of the electron transport material in the region exceeding 4% in the thickness direction of the undercoat layer from the interface between the undercoat layer and the charge generation layer are calculated from a measured depth profile to obtain the ratio (X1/X2).

### Area Ratio

In the cross section in the thickness direction of the undercoat layer according to the second exemplary embodiment, the ratio (Y1/Y2) of the area ratio Y1(%) of the electron transport material in the region within 4% in the thickness direction of the undercoat layer from an interface between the undercoat layer and the charge generation layer to the area ratio Y2(%) of the electron transport material in the region exceeding 4% in the thickness direction of the undercoat layer from the interface between the undercoat layer and the charge generation layer is 0 or 81 or less, for example, preferably 0 or 79 or less, and more preferably 0 or 77 or less.

In the cross section in the thickness direction of the undercoat layer according to the first exemplary embodiment, the ratio (Y1/Y2) of the area ratio Y1(%) of the electron transport material in the region within 4% in the thickness direction of the undercoat layer from the interface between the undercoat layer and the charge generation layer to the area ratio Y2(%) of the electron transport material in the region exceeding 4% in the thickness direction of the undercoat layer from the interface between the undercoat layer and the charge generation layer is 0 or 81 or less, for example, preferably 0 or 79 or less, and more preferably 0 or 77 or less.

In a case where the ratio (Y1/Y2) is 0 or 81 or less, the content of the electron transport material is small on the interface side between the undercoat layer and the charge generation layer, or the electron transport material is not contained on the interface side between the undercoat layer and the charge generation layer. Therefore, the infiltration of the electron transport material contained in the undercoat layer into the charge generation layer is further suppressed. As a result, even in a case of long-term operation in a high-temperature and high-humidity environment, the infiltration of moisture that has infiltrated from the surface layer side into the undercoat layer is suppressed. Accordingly, even in a case of long-term operation in a high-temperature and high-humidity environment, the electron transport material contained in the undercoat layer is suppressed from being electrochemically corroded, and thus the charge retention property is excellent.

In the cross section in the thickness direction of the undercoat layer, the area ratio Y1 of the electron transport material in the region within 4% in the above-described thickness direction of the undercoat layer from the interface between the undercoat layer and the charge generation layer is, for example, preferably 0% or 63% or less, more preferably 0% or 60% or less, and still more preferably 0% or 58% or less.

In a case where the Y is 0% or 63% or less, the content of the electron transport material is small on the interface side between the undercoat layer and the charge generation layer, or the electron transport material is not contained on the interface side between the undercoat layer and the charge generation layer. Therefore, infiltration of moisture that has infiltrated from the surface layer side into the undercoat layer is suppressed. Accordingly, even in a case of long-term operation in a high-temperature and high-humidity environment, the electron transport material contained in the undercoat layer is suppressed from being electrochemically corroded, and thus the charge retention property is excellent.

In the cross section in the thickness direction of the undercoat layer, the area ratio Y2 of the electron transport material in the region exceeding 4% in the above-described thickness direction of the undercoat layer from the interface between the undercoat layer and the charge generation layer is, for example, preferably 60% or more and 80% or less, more preferably 65% or more and 77% or less, and still more preferably 70% or more and 75% or less.

In a case where the Y2 is 60% or more, the electron transport material in the undercoat layer is sufficiently close to each other, and thus the electron transport performance is excellent; and in a case where the Y2 is 80% or less, aggregation of particles in the undercoat layer is suppressed, that is excellent in terms of electrical properties and mechanical strength.

A method of setting the above-described Y1, Y2, and ratio (Y1/Y2) to the above-described ranges is not particularly limited, and examples thereof include a method of preparing two kinds of coating solutions for forming an undercoat layer, in which the concentration of the electron transport material is different from each other, and forming a coating film so that the concentration of the electron transport material on the interface side with the charge generation layer is reduced; and a method of thinly coating the interface side of the undercoat layer with the charge generation layer with a resin layer not containing the electron transport material.

A method of confirming the above-described Y1, Y2, and ratio (Y1/Y2) is as follows.

The electrophotographic photoreceptor is cut in the thickness direction to the undercoat layer, and a test piece having this cross section as an observation surface is obtained. The observation surface of the test piece is observed with a scanning electron microscope (SEM) device (manufactured by Hitachi, Ltd.; S-4100) in a visual field of 500 nm×500 nm or more to capture an image. The image is taken in an image analyzer (LUZEXIII, manufactured by NIRECO).

The total area of the region within 4% in the above-described thickness direction of the undercoat layer from the interface between the undercoat layer and the charge generation layer is determined by image analysis. Next, the observation surface of the test piece is subjected to element analysis by energy dispersive X-ray spectroscopy, and mapping analysis is performed on the elements on the observation surface.

Thereafter, a portion in which an element contained in a large amount in the electron transport material (for example, an oxygen atom in the compound P-1) is concentrated is defined as an amount of the electron transport material, and the area Y1 of the electron transport material in the region within 4% in the above-described thickness direction of the undercoat layer from the interface between the undercoat layer and the charge generation layer and the area Y2 of the electron transport material in the region exceeding 4% in the above-described thickness direction of the undercoat layer from the interface between the undercoat layer and the charge generation layer are calculated. Thereafter, the ratio (Y1/Y2) is obtained.

Hereinafter, aspects common to the undercoat layer in the first exemplary embodiment and the undercoat layer in the second exemplary embodiment will be described.

Hereinafter, in a case of common matters between the undercoat layer in the first exemplary embodiment and the undercoat layer in the second exemplary embodiment, the term “undercoat layer” will be simply used.

An average thickness of the undercoat layer is, for example, preferably 2 μm or more and 15 μm or less.

In a case where the average thickness is 2 μm or more, covering property of the base material is ensured, and the charge retention property is more excellent.

In a case where the average thickness is 15 μm or less, carriers from the charge generation layer can reach the aluminum base material within a time required for image formation, that is excellent from the viewpoint of initial electron transport ability. In addition, for example, the fact is also preferable from the viewpoint of manufacturing cost.

### Electron Transport Material

The undercoat layer contains an electron transport material.

Examples of the electron transport material include electron transport materials, for example, a quinone-based compound such as chloranil and bromanil; a tetracyanoquinodimethane-based compound; a fluorenone compound such as 2,4,7-trinitrofluorenone and 2,4,5,7-tetranitro-9-fluorenone; an oxadiazole-based compound such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; a xanthone-based compound; a thiophene compound; a diphenoquinone compound such as 3,3′,5,5′-tetra-t-butyldiphenoquinone; and an acid anhydride such a as perinone compound, dibromoanthanthrone, and perylenetetracarboxylic acid dianhydride.

Among the above, from the viewpoint of more excellent charge retention property, for example, the electron transport material preferably includes an acid anhydride having electron transport performance, and more preferably includes a compound represented by Formula (P), that is perylenetetracarboxylic acid dianhydride.

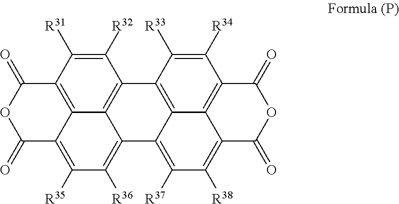

In Formula (P), R³¹, R³², R³³, R³⁴, R³⁵, R³⁶, R³⁷, and R³⁸ each independently represent a hydrogen atom, an alkyl group, an alkoxy group, an aralkyl group, an aryl group, an alkoxycarbonyl group, or a halogen atom.

The compound represented by Formula (P) has excellent electron transport properties and low hole transport properties. Therefore, in a case where the undercoat layer contains the compound represented by Formula (P), the undercoat layer has excellent electron transport properties, the conductive path in the undercoat layer is likely to be secured, and leakage current is further suppressed. In addition, the charge retention property is more excellent because the dark decay is further reduced.

In Formula (P), for example, R³¹, R³², R³³, R³⁴, R³⁵, R³⁶, R³⁷, and R³⁸ each independently preferably represent a hydrogen atom, an alkyl group, or a halogen atom, and more preferably represent a hydrogen atom.

In Formula (P), in a case where R³¹ to R³⁸ are a hydrogen atom, an alkyl group, or a halogen atom (for example, more preferably a hydrogen atom), the undercoat layer has more excellent electron transport properties, the conductive path in the undercoat layer is likely to be secured, and the charge retention property is excellent even in a case of being operated for a long period of time in a high-temperature and high-humidity environment (for example, performing a cycle of charging and exposure of the electrophotographic photoreceptor at 30° C. and 80% RH 10,000 times).

Examples of the alkyl group represented by R³¹ to R³⁸ in Formula (P) include a substituted or unsubstituted alkyl group.

Examples of the unsubstituted alkyl group represented by R³¹ to R³⁸ in Formula (P) include a linear alkyl group having 1 or more and 20 or less carbon atoms (for example, preferably having 1 or more and 10 or less carbon atoms and more preferably having 1 or more and 6 or less carbon atoms), a branched alkyl group having 3 or more and 20 or less carbon atoms (for example, preferably having 3 or more and 10 or less carbon atoms), and a cyclic alkyl group having 3 or more and 20 or less carbon atoms (for example, preferably having 3 or more and 10 or less carbon atoms).

Examples of the linear alkyl group having 1 or more and 20 or less carbon atoms include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, a tridecyl group, an n-tetradecyl group, an n-pentadecyl group, an n-heptadecyl group, an n-octadecyl group, an n-nonadecyl group, and an n-icosyl group.

Specific examples of the branched alkyl group having 3 or more and 20 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isododecyl group, a sec-dodecyl group, a tert-dodecyl group, a tert-tetradecyl group, and a tert-pentadecyl group.

Examples of the cyclic alkyl group having 3 or more and 20 or less carbon atoms include a cyclopropyl group, a cyclobutyl group, a cyclopentyl group, a cyclohexyl group, a cycloheptyl group, a cyclooctyl group, a cyclononyl group, a cyclodecyl group, and the like, and a polycyclic (for example, bicyclic, tricyclic, spirocyclic, or the like) alkyl group composed of these monocyclic alkyl groups linked to each other.

Among the above, for example, a linear alkyl group such as a methyl group and an ethyl group is preferable as the unsubstituted alkyl group.

Examples of the substituent in the alkyl group include an alkoxy group, a hydroxy group, a carboxy group, a nitro group, and a halogen atom (such as a fluorine atom, a bromine atom, and an iodine atom).

Examples of the alkoxy group that substitutes the hydrogen atom in the alkyl group include the same groups as the groups for the unsubstituted alkoxy group represented by R³¹ to R³⁸ in Formula (P).

Examples of the alkoxy group represented by R³¹ to R³⁸ in Formula (P) include a substituted or unsubstituted alkoxy group.

Examples of the unsubstituted alkoxy group represented by R³¹ to R³⁸ in Formula (P) include a linear, branched, or cyclic alkoxy group having 1 or more and 10 or less carbon atoms (for example, preferably having 1 or more and 6 or less carbon atoms, and more preferably having 1 or more and 4 or less carbon atoms).

Specific examples of the linear alkoxy group include a methoxy group, an ethoxy group, an n-propoxy group, an n-butoxy group, an n-pentyloxy group, an n-hexyloxy group, an n-heptyloxy group, an n-octyloxy group, an n-nonyloxy group, and an n-decyloxy group.

Specific examples of the branched alkoxy group include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, and a tert-decyloxy group.

Specific examples of the cyclic alkoxy group include a cyclopropoxy group, a cyclobutoxy group, a cyclopentyloxy group, a cyclohexyloxy group, a cycloheptyloxy group, a cyclooctyloxy group, a cyclononyloxy group, and a cyclodecyloxy group.

Among the above, for example, a linear alkoxy group is preferable as the unsubstituted alkoxy group.

Examples of the substituent in the alkoxy group include an aryl group, an alkoxycarbonyl group, an aryloxycarbonyl group, a hydroxyl group, a carboxy group, a nitro group, and a halogen atom (such as a fluorine atom, a bromine atom, and an iodine atom).

Examples of the aryl group that substitutes the hydrogen atom in the alkoxy group include the same groups as the groups for the unsubstituted aryl group represented by R³¹ to R³⁸ in Formula (P).

Examples of the alkoxycarbonyl group that substitutes the hydrogen atom in the alkoxy group include the same groups as the groups for the unsubstituted alkoxycarbonyl group represented by R³¹ to R³⁸ in Formula (P).

Examples of the aryloxycarbonyl group that substitutes the hydrogen atom in the alkoxy group include the same groups as the groups for the unsubstituted aryloxycarbonyl group represented by R³¹ to R³⁸ in Formula (P).

Examples of the aralkyl group represented by R³¹ to R³⁸ in Formula (P) include a substituted or unsubstituted aralkyl group.

As the unsubstituted aralkyl group represented by R³¹ to R³⁸ in Formula (P), for example, an aralkyl group having 7 or more and 30 or less carbon atoms is preferable, an aralkyl group having 7 or more and 16 or less carbon atoms is more preferable, and an aralkyl group having 7 or more and 12 or less carbon atoms is still more preferable.

Examples of the unsubstituted aralkyl group having 7 or more and 30 or less carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthracenylmethyl group, and a phenyl-cyclopentylmethyl group.

Examples of the substituent in the aralkyl group include an alkoxy group, an alkoxycarbonyl group, and a halogen atom (such as a fluorine atom, a bromine atom, and an iodine atom).

Examples of the alkoxy group that substitutes the hydrogen atom in the aralkyl group include the same groups as the groups for the unsubstituted alkoxy group represented by R³¹ to R³⁸ in Formula (P).

Examples of the alkoxycarbonyl group that substitutes the hydrogen atom in the aralkyl group include the same groups as the groups for the unsubstituted alkoxycarbonyl group represented by R³¹ to R³⁸ in Formula (P).

Examples of the aryl group represented by R³¹ to R³⁸ in Formula (P) include a substituted or unsubstituted aryl group.

As the unsubstituted aryl group represented by R³¹ to R³⁸ in Formula (P), for example, an aryl group having 6 or more and 30 or less carbon atoms is preferable, an aryl group having 6 or more and 14 or less carbon atoms is more preferable, and an aryl group having 6 or more and 10 or less carbon atoms is still more preferable.

Examples of the aryl group having 6 or more and 30 or less carbon atoms include a phenyl group, a biphenyl group, a 1-naphthyl group, a 2-naphthyl group, a 9-anthryl group, a 9-phenanthryl group, a 1-pyrenyl group, a 5-naphthacenyl group, a 1-indenyl group, a 2-azulenyl group, a 9-fluorenyl group, a biphenylenyl group, an indacenyl group, a fluoranthenyl group, an acenaphthylenyl group, an aceanthrylenyl group, a phenalenyl group, a fluorenyl group, an anthryl group, a bianthracenyl group, a teranthracenyl group, a quarteranthracenyl group, an anthraquinolyl group, a phenanthryl group, a triphenylenyl group, a pyrenyl group, a chrysenyl group, a naphthacenyl group, a preadenyl group, a picenyl group, a perylenyl group, a pentaphenyl group, a pentacenyl group, a tetraphenylenyl group, a hexaphenyl group, a hexacenyl group, a rubisenyl group, and a coronenyl group. Among the above, for example, a phenyl group is preferable.

Examples of the substituent in the aryl group include an alkyl group, an alkoxy group, an alkoxycarbonyl group, an aryloxycarbonyl group, and a halogen atom (such as a fluorine atom, a bromine atom, and an iodine atom).

Examples of the alkyl group that substitutes the hydrogen atom in the aryl group include the same groups as the groups for the unsubstituted alkyl group represented by R³¹ to R³⁸ in Formula (P).

Examples of the alkoxy group that substitutes the hydrogen atom in the aryl group include the same groups as the groups for the unsubstituted alkoxy group represented by R³¹ to R³⁸ in Formula (P).

Examples of the alkoxycarbonyl group that substitutes the hydrogen atom in the aryl group include the same groups as the groups for the unsubstituted alkoxycarbonyl group represented by R³¹ to R³⁸ in Formula (P).

Examples of the alkoxycarbonyl group represented by R³¹ to R³⁸ in Formula (P) include a substituted or unsubstituted alkoxycarbonyl group.

The number of carbon atoms in an alkyl chain of the unsubstituted alkoxycarbonyl group represented by R³¹ to R³⁸ in Formula (P) is, for example, preferably 1 or more and 20 or less, more preferably 1 or more and 15 or less, and still more preferably 1 or more and 10 or less.

Examples of the alkoxycarbonyl group having 1 or more and 20 or less carbon atoms in the alkyl chain include a methoxycarbonyl group, an ethoxycarbonyl group, a propoxycarbonyl group, an isopropoxycarbonyl group, an n-butoxycarbonyl group, a sec-butoxybutylcarbonyl group, a tert-butoxycarbonyl group, a pentaoxycarbonyl group, a hexaoxycarbonyl group, a heptaoxycarbonyl group, an octaoxycarbonyl group, a nonaoxycarbonyl group, a decaoxycarbonyl group, a dodecaoxycarbonyl group, a tridecaoxycarbonyl group, a tetradecaoxycarbonyl group, a pentadecaoxycarbonyl group, a hexadecaoxycarbonyl group, a heptadecaoxycarbonyl group, an octadecaoxycarbonyl group, a nonadecaoxycarbonyl group, and an icosaoxycarbonyl group.

Examples of the substituent in the alkoxycarbonyl group include an aryl group, a hydroxy group, and a halogen atom (such as a fluorine atom, a bromine atom, and an iodine atom).

Examples of the aryl group that substitutes the hydrogen atom in the alkoxycarbonyl group include the same groups as the groups for the unsubstituted aryl group represented by R³¹ to R³⁸ in Formula (P).

Examples of the halogen atom represented by R³¹ to R³⁸ in Formula (P) include a fluorine atom, a chlorine atom, a bromine atom, and an iodine atom.

Exemplary compounds of the compound represented by Formula (P) are shown below, but the present exemplary embodiment is not limited thereto. The following exemplary compound numbers will be referred to as exemplary compounds (P-numbers) below.

| Exemplary | Exemplary compound of compound | Exemplary | Exemplary compound of compound |
|---|---|---|---|
| number | represented by Formula (P) | number | represented by Formula (P) |
| P-1 | 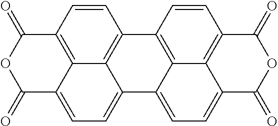 [SMILES: O=C1OC(=O)c2ccc3c4ccc5c6c(ccc(c7ccc1c2c73)c64)C(=O)OC5=O] | P-6 | 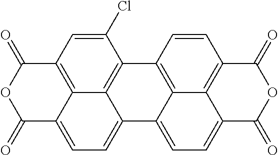 [SMILES: O=C1OC(=O)c2ccc3c4c(Cl)cc5c6c(ccc(c7ccc1c2c73)c64)C(=O)OC5=O] |
| P-2 | 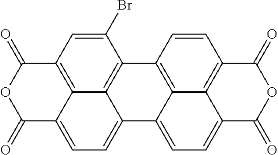 [SMILES: O=C1OC(=O)c2ccc3c4c(Br)cc5c6c(ccc(c7ccc1c2c73)c64)C(=O)OC5=O] | P-7 | 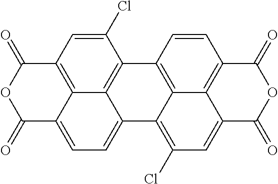 [SMILES: O=C1OC(=O)c2cc(Cl)c3c4ccc5c6c(cc(Cl)c(c7ccc1c2c73)c64)C(=O)OC5=O] |
| P-3 | 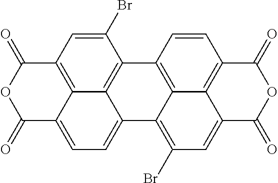 [SMILES: O=C1OC(=O)c2cc(Br)c3c4ccc5c6c(cc(Br)c(c7ccc1c2c73)c64)C(=O)OC5=O] | P-8 | 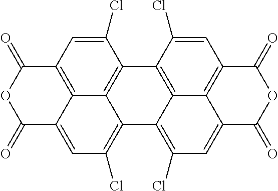 [SMILES: O=C1OC(=O)c2cc(Cl)c3c4c(Cl)cc5c6c(cc(Cl)c(c7c(Cl)cc1c2c73)c64)C(=O)OC5=O] |
| P-4 | 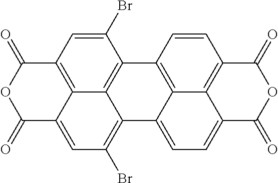 [SMILES: O=C1OC(=O)c2ccc3c4c(Br)cc5c6c(cc(Br)c(c7ccc1c2c73)c64)C(=O)OC5=O] | P-9 | 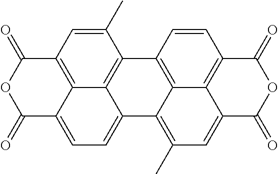 [SMILES: Cc1cc2c3c(ccc4c5c(C)cc6c7c(ccc(c1c34)c75)C(=O)OC6=O)C(=O)OC2=O] |
| P-5 | 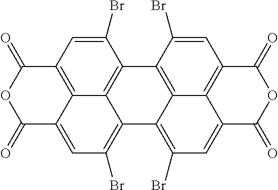 [SMILES: O=C1OC(=O)c2cc(Br)c3c4c(Br)cc5c6c(cc(Br)c(c7c(Br)cc1c2c73)c64)C(=O)OC5=O] | P-10 | 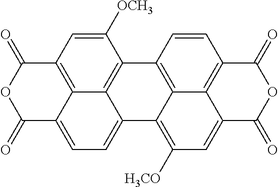 [SMILES: COc1cc2c3c(ccc4c5c(OC)cc6c7c(ccc(c1c34)c75)C(=O)OC6=O)C(=O)OC2=O] |
| P-11 | 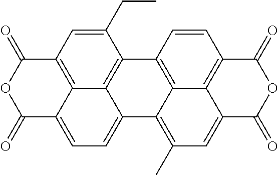 [SMILES: CCc1cc2c3c(ccc4c5c(C)cc6c7c(ccc(c1c34)c75)C(=O)OC6=O)C(=O)OC2=O] | P-15 | 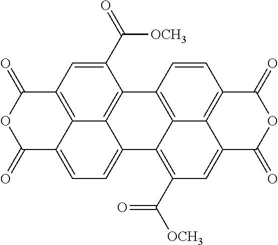 [SMILES: COC(=O)c1cc2c3c(ccc4c5c(C(=O)OC)cc6c7c(ccc(c1c34)c75)C(=O)OC6=O)C(=O)OC2=O] |
| P-12 | 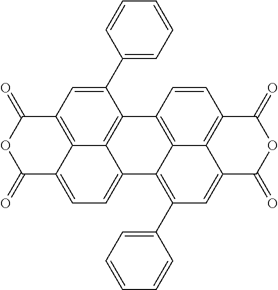 [SMILES: O=C1OC(=O)c2cc(-c3ccccc3)c3c4ccc5c6c(cc(-c7ccccc7)c(c7ccc1c2c73)c64)C(=O)OC5=O] | P-16 | 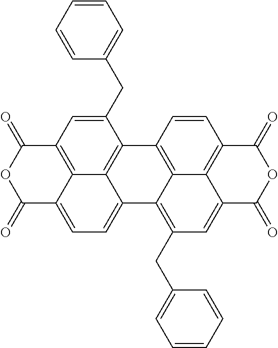 [SMILES: O=C1OC(=O)c2cc(Cc3ccccc3)c3c4ccc5c6c(cc(Cc7ccccc7)c(c7ccc1c2c73)c64)C(=O)OC5=O] |
| P-13 | 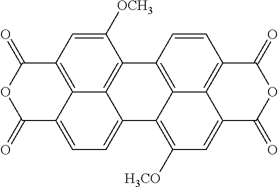 [SMILES: COc1cc2c3c(ccc4c5c(OC)cc6c7c(ccc(c1c34)c75)C(=O)OC6=O)C(=O)OC2=O] | P-17 | 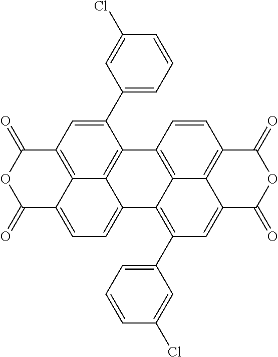 [SMILES: O=C1OC(=O)c2cc(-c3cccc(Cl)c3)c3c4ccc5c6c(cc(-c7cccc(Cl)c7)c(c7ccc1c2c73)c64)C(=O)OC5=O] |
| P-14 | 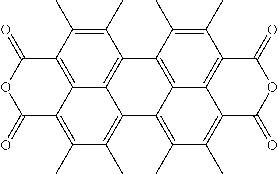 [SMILES: Cc1c2c3c(c(C)c(C)c4c5c(C)c(C)c6c7c(c(C)c(C)c(c(c1C)c34)c75)C(=O)OC6=O)C(=O)OC2=O] | P-18 | 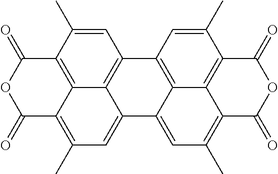 [SMILES: Cc1cc2c3cc(C)c4c5c(c(C)cc(c6cc(C)c7c(c1C(=O)OC7=O)c26)c53)C(=O)OC4=O] |

An average primary particle size of the electron transport material is, for example, preferably 20 nm or more and 1,000 nm or less, more preferably 30 nm or more and 800 nm or less, and still more preferably 50 nm or more and 700 nm or less.

In a case where the average primary particle size of the electron transport material is 20 nm or more, aggregation of the electron transport material in the undercoat layer is suppressed, and the electron transport material is likely to be present with high dispersibility. As a result, the electron transport properties are more excellent, and the hole transport properties are likely to be further lowered. Accordingly, the electron transport properties are more excellent, the hole transport properties are likely to be further lowered, and the charge retention property is more excellent.

In a case where the average primary particle size of the electron transport material is 1,000 nm or less, the electron transport material is likely to be localized in the undercoat layer and is likely to be present with high dispersibility. As a result, the electron transport properties are more excellent, the hole transport properties are likely to be further lowered, and the charge retention property is more excellent.

The average primary particle size of the electron transport material is determined as follows.

The electron transport material is specified by observing the laminated cross section of the undercoat layer of the photoreceptor in the thickness direction at a magnification of 100,000 times using a scanning electron microscope (SEM). Particle diameters of any 10 particles in the obtained SEM image, present as the primary particles in the electron transport material, are determined. An arithmetic average value of the obtained particle diameters is defined as the average primary particle size of the electron transport material.

In the compound represented by Formula (P), an aspect ratio is, for example, preferably 1.0 or more and 5 or less, more preferably 1.1 or more and 3 or less, and still more preferably 1.2 or more and 2.5 or less.

In a case where the aspect ratio of the compound represented by Formula (P) is 2.5 or less, the electron transport material is likely to be present in the undercoat layer with high dispersibility, and thus the electron transport properties are more excellent and the hole transport properties are likely to be further lowered. In a case where the aspect ratio of the compound represented by Formula (P) is 1.0 or more and 5 or less, the electron transport material is likely to be present in the undercoat layer with high dispersibility, and thus the electron transport properties are more excellent and the charge retention property is likely to be maintained.

The aspect ratio of the compound represented by Formula (P) means a ratio (length of major axis/length of minor axis) of a length of a major axis of the electron transport material to a length of a minor axis of the electron transport material.

The above-described length of the electron transport material in the major axis direction denotes the distance of the longest straight line formed by connecting one end portion and the other end portion of the electron transport material in the major axis direction. The above-described length of the electron transport material in the minor axis direction denotes the distance of the longest straight line formed by connecting one end portion and the other end portion of the electron transport material in a direction orthogonal to the major axis.

The compound represented by Formula (P) is specified by removing the photosensitive layer (and the protective layer as necessary) from the photoreceptor and observing the undercoat layer with a field emission scanning electron microscope (JSM-6700F, manufactured by JEOL Ltd.) at a magnification of 3,000 to 100,000 times. The length of the major axis and the length of the minor axis are measured at any ten points of the electron transport material on the obtained micrograph, and each of aspect ratios (length of major axis/length of minor axis) is determined. The arithmetic average value of the obtained aspect ratios is defined as the aspect ratio of the compound represented by Formula (P).

A method of adjusting the average primary particle size and the aspect ratio of the compound represented by Formula (P) to be in the above-described ranges is not particularly limited, and examples thereof include a method of pulverizing the electron transport material using a ball mill, a bead mill, a mortar, a sand mill, a kneader, an attritor or the like and a method of precipitating microcrystals by dissolving the electron transport material in fluoroacetic acid, sulfuric acid, or the like and bringing the mixture into contact with water or a poor solvent.

A proportion of the total amount of the compound represented by Formula (P) to the total amount of the electron transport material in the undercoat layer is, for example, preferably 80% by mass or more and 100% by mass or less, more preferably 90% by mass or more and 100% by mass or less, and still more preferably 95% by mass or more and 100% by mass or less.

The total amount of the electron transport material containing the compound represented by Formula (P) in the entire specific undercoat layer may be less than 70% by mass with respect to the total solid content of the specific undercoat layer.

In the related art, from the viewpoint of charge retention property, the content of the electron transport material is, for example, preferably 70% by mass or more with respect to the total solid content of the undercoat layer. On the other hand, in the present exemplary embodiment, since the charge transport material contains the compound represented by Formula (P) having low hole transport properties in addition to excellent electron transport properties, even in a case where the total amount of the electron transport material is less than 70% by mass, the charge retention property is excellent.

The total amount of the electron transport material may be 60% by mass or more, or 60% by mass or more and 70% by mass or less with respect to the total solid content of the undercoat layer. In a case where the content of the electron transport material is 70% by mass or less, degradation of the film quality, a decrease in film forming properties, and occurrence of surface roughness on the undercoat layer are suppressed, and thus the charge retention property is more excellent. On the other hand, in a case where the content of the electron transport material is 60% by mass or more, sufficient electron transportability is exhibited, and the charge retention property is sufficiently ensured.

### Binder Resin

Examples of the binder resin include known polymer compounds such as a polyarylate resin, a polycarbonate resin, an acetal resin (for example, polyvinyl butyral or the like), a polyvinyl alcohol resin, a polyvinyl acetal resin, a casein resin, a diallyl phthalate resin, a polyamide resin, a nylon resin, a nylon polyamide resin, a cellulose resin, gelatin, a urethane resin, a melamine resin, a benzoguanamine resin (for example, a methylated benzoguanamine resin or the like), a polyester resin, an unsaturated polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a urea resin, a phenol resin (for example, a resol type phenol resin or the like), a phenol-formaldehyde resin, an alkyd resin, and an epoxy resin; a zirconium chelate compound; a titanium chelate compound; an aluminum chelate compound; a titanium alkoxide compound; an organic titanium compound; and known materials such as a silane coupling agent.

Examples of the binder resin also include a charge-transporting resin having a charge-transporting group, and a conductive resin (for example, polyaniline or the like).

In the present specification, the binder resin includes a resin obtained by a reaction between the resin described above and a curing agent, and also includes a resin obtained by a reaction of a curing agent.

As the binder resin used for the undercoat layer, for example, a resin insoluble in a coating solvent of the upper layer is suitable. As the binder resin used for the undercoat layer, for example, a resin obtained by reacting at least one selected from a diallyl phthalate resin, a polyamide resin, a nylon resin, a urethane resin, a melamine resin, a benzoguanamine resin, and a phenol resin; or a resin obtained by reacting at least one selected from these resins with a curing agent is preferable. In a case where the binder resin includes at least one resin selected from the above-described group, blocking property of holes is high, and the charge retention property is more excellent.

The undercoat layer may further contain inorganic particles.

Examples of the inorganic particles include inorganic particles having a powder resistance (volume resistivity) of 10²Ω·cm or more and 10¹¹Ω·cm or less.

Among the above, as the inorganic particles having the above-described resistance value, for example, metal oxide particles such as tin oxide particles, titanium oxide particles, zinc oxide particles, and zirconium oxide particles may be used, and zinc oxide particles are particularly preferable.

A specific surface area of the inorganic particles, measured by a BET method, may be, for example, 10 m²/g or more.

A volume-average particle diameter of the inorganic particles may be 50 nm or more and 2,000 nm or less (for example, preferably 60 nm or more and 1,000 nm or less).

A content of the inorganic particles is, for example, preferably 10% by mass or more and 80% by mass or less, and more preferably 40% by mass or more and 80% by mass or less with respect to the binder resin.

The inorganic particles may be subjected to a surface treatment. As the inorganic particles, two or more kinds of inorganic particles subjected to different surface treatments or two or more kinds of inorganic particles having different particle diameters may be used in a form of a mixture.

Examples of a surface treatment agent include a silane coupling agent, a titanate-based coupling agent, an aluminum-based coupling agent, and a surfactant. In particular, for example, a silane coupling agent is preferable, and a silane coupling agent having an amino group is more preferable.

Examples of the silane coupling agent having an amino group include 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane; but the present invention is not limited thereto.

The silane coupling agent may be used in a form of a mixture of two or more kinds thereof. For example, the silane coupling agent having an amino group and other silane coupling agents may be used in combination. Examples of the other silane coupling agents include vinyltrimethoxysilane, 3-methacryloxypropyl-tris(2-methoxyethoxy) silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane; but the present invention is not limited thereto.

A surface treatment method using the surface treatment agent may be any method as long as the method is a known method, and any of a dry method or a wet method may be used.

A treatment amount of the surface treatment agent is, for example, preferably 0.5% by mass or more and 10% by mass or less with respect to the inorganic particles.

Here, for example, the undercoat layer may contain an electron-accepting compound (acceptor compound) together with the inorganic particles from the viewpoint of enhancing long-term stability of electrical properties and carrier blocking properties.

Examples of the electron-accepting compound include electron-transporting substances, for example, a compound having an anthraquinone structure; a quinone-based compound such as chloranil and bromanil; a tetracyanoquinodimethane-based compound; a fluorenone compound such as 2,4,7-trinitrofluorenone and 2,4,5,7-tetranitro-9-fluorenone; an oxadiazole-based compound such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; a xanthone-based compound; a thiophene compound; a diphenoquinone compound such as 3,3′,5,5′-tetra-t-butyldiphenoquinone; and a benzophenone compound.

In particular, as the electron-accepting compound, for example, a compound having an anthraquinone structure is preferable. As the compound having an anthraquinone structure, for example, a hydroxyanthraquinone compound, an aminoanthraquinone compound, or an aminohydroxyanthraquinone compound is preferable; and specifically, anthraquinone, alizarin, quinizarin, anthrarufin, purpurin, or a derivative thereof is preferable.

The electron-accepting compound may be contained in the undercoat layer in a state of being dispersed with the inorganic particles, or in a state of being attached to the surface of the inorganic particles.

Examples of a method of attaching the electron-accepting compound to the surface of the inorganic particles include a dry method and a wet method.

The dry method is, for example, a method of attaching the electron-accepting compound to the surface of the inorganic particles by adding the electron-accepting compound dropwise to the inorganic particles directly or by dissolving the electron-accepting compound in an organic solvent while stirring the inorganic particles with a mixer having a large shearing force and spraying the mixture together with dry air or nitrogen gas. For example, the dropwise addition or spraying of the electron-accepting compound may be performed at a temperature equal to or lower than a boiling point of the solvent. After the dropwise addition or spraying of the electron-accepting compound, the mixture may be further baked at 100° C. or higher. The baking is not particularly limited as long as the temperature and the time are adjusted such that electrophotographic characteristics can be obtained.

The wet method is, for example, a method of attaching the electron-accepting compound to the surface of the inorganic particles by adding the electron-accepting compound to inorganic particles while dispersing the inorganic particles in a solvent by performing using a stirrer, an ultrasonic disperser, a sand mill, an attritor, or a ball mill, stirring or dispersing the mixture, and removing the solvent. The solvent removing method is carried out by, for example, filtration or distillation so that the solvent is distilled off. After removal of the solvent, the mixture may be further baked at 100° C. or higher. The baking is not particularly limited as long as the temperature and the time are adjusted such that electrophotographic characteristics can be obtained. In the wet method, the moisture contained in the inorganic particles may be removed before the electron-accepting compound is added, and examples thereof include a method of removing the moisture while stirring and heating the inorganic particles in a solvent and a method of removing the moisture by azeotropically boiling the inorganic particles with a solvent.

The electron-accepting compound may be attached before or after the inorganic particles are subjected to the surface treatment with the surface treatment agent or simultaneously with the surface treatment with the surface treatment agent.

A content of the electron-accepting compound may be, for example, 0.01% by mass or more and 20% by mass or less, preferably 0.01% by mass or more and 10% by mass or less with respect to the inorganic particles.

The undercoat layer may contain various additives for improving the electrical properties, the environmental stability, and the image quality.

Examples of the additive include known materials, for example, an electron-transporting material such as a polycyclic condensed material or an azo-based material, a zirconium chelate compound, a titanium chelate compound, an aluminum chelate compound, a titanium alkoxide compound, an organic titanium compound, and a silane coupling agent. The silane coupling agent is used for the surface treatment of the inorganic particles as described above, but may be further added to the undercoat layer as the additive.

Examples of the silane coupling agent as the additive include vinyltrimethoxysilane, 3-methacryloxypropyl-tris(2-methoxyethoxy) silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compound include zirconium butoxide, ethyl zirconium acetoacetate, zirconium triethanolamine, acetylacetonate zirconium butoxide, ethyl zirconium butoxide acetoacetate, zirconium acetate, zirconium oxalate, zirconium lactate, zirconium phosphonate, zirconium octanoate, zirconium naphthenate, zirconium laurate, zirconium stearate, zirconium isostearate, zirconium butoxide methacrylate, stearate zirconium butoxide, and isostearate zirconium butoxide.

Examples of the titanium chelate compound include tetraisopropyl titanate, tetranormal butyl titanate, a butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compound include aluminum isopropylate, monobutoxyaluminum diisopropylate, aluminum butyrate, diethylacetoacetate aluminum diisopropylate, and aluminum tris(ethylacetoacetate).

These additives may be used alone or in a form of a mixture or a polycondensate of a plurality of compounds.

The undercoat layer may have, for example, a Vickers hardness of 35 or more.

For example, the surface roughness (ten-point average roughness) of the undercoat layer may be adjusted to ½ from 1/(4n) (n represents a refractive index of an upper layer) of a laser wavelength λ for exposure to be used to suppress moire fringes.

Resin particles or the like may be added to the undercoat layer to adjust the surface roughness. Examples of the resin particles include silicone resin particles and crosslinked polymethyl methacrylate resin particles. In addition, the surface of the undercoat layer may be polished to adjust the surface roughness. Examples of a polishing method include buff polishing, a sandblast treatment, wet honing, and a grinding treatment.

The formation of the undercoat layer is not particularly limited, and a known forming method is used. For example, a coating film of a coating solution for forming the undercoat layer, in which the above-described components are added to a solvent, is formed, and the coating film is dried and then heated as necessary.

Examples of the solvent for preparing the coating solution for forming the undercoat layer include known organic solvents such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of the solvent include typical organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method of dispersing the inorganic particles in a case of preparing the coating solution for forming the undercoat layer include known methods such as a roll mill, a ball mill, a vibration ball mill, an attritor, a sand mill, a colloid mill, and a paint shaker.

Examples of the method of coating the conductive substrate with the coating solution for forming the undercoat layer include typical coating methods such as a blade coating method, a wire bar coating method, a spray coating method, a dip coating method, a bead coating method, an air knife coating method, and a curtain coating method.

### Conductive Substrate

Examples of the conductive substrate include metal plates, metal drums, metal belts, or the like, containing a metal (such as aluminum, copper, zinc, chromium, nickel, molybdenum, vanadium, indium, gold, and platinum) or an alloy (such as stainless steel). In addition, examples of the conductive substrate also include paper, a resin film, a belt, or the like, that is obtained by being coated, vapor-deposited, or laminated with a conductive compound (such as a conductive polymer and indium oxide), a metal (such as aluminum, palladium, and gold) or an alloy. Here, the term “conductive” denotes that a volume resistivity is less than 10¹³Ω·cm.

In a case where the electrophotographic photoreceptor is used in a laser printer, for example, it is preferable that a surface of the conductive substrate is roughened such that a centerline average roughness Ra thereof is 0.04 μm or more and 0.5 μm or less for the purpose of suppressing interference fringes from occurring in a case of irradiation with laser beams. In a case where incoherent light is used as a light source, roughening of the surface to prevent the interference fringes is not particularly necessary, and it is appropriate for longer life because occurrence of defects due to the roughness of the surface of the conductive substrate is suppressed.

Examples of the roughening method include wet honing performed by suspending an abrasive in water and spraying the suspension to the conductive substrate, centerless grinding performed by pressure-welding the conductive substrate against a rotating grindstone and continuously grinding the conductive substrate, and an anodizing treatment.

Examples of the roughening method also include a method of dispersing conductive or semi-conductive powder in a resin without roughening the surface of the conductive substrate to form a layer on the surface of the conductive substrate, and performing roughening using the particles dispersed in the layer.

The roughening treatment by anodization is a treatment of forming an oxide film on the surface of the conductive substrate by carrying out anodization in an electrolytic solution using a conductive substrate made of a metal (for example, aluminum) as an anode. Examples of the electrolytic solution include a sulfuric acid solution and an oxalic acid solution. However, a porous anodized film formed by the anodization is chemically active in a natural state, is easily contaminated, and has a large resistance fluctuation depending on the environment. Therefore, for example, it is preferable that a sealing treatment is performed on the porous anodized film so that micropores of the oxide film are closed by volume expansion due to a hydration reaction in pressurized steam or boiling water (a metal salt such as nickel may be added thereto) for a change into a more stable a hydrous oxide.

A film thickness of the anodized film is, for example, preferably 0.3 μm or more and 15 μm or less. In a case where the film thickness is within the above-described range, barrier properties against injection tend to be exhibited, and an increase in the residual potential due to repeated use tends to be suppressed.

The conductive substrate may be subjected to a treatment with an acidic treatment liquid or a boehmite treatment.

The treatment with an acidic treatment liquid is carried out, for example, as follows. First, an acidic treatment liquid containing phosphoric acid, chromic acid, and hydrofluoric acid is prepared. As a blending proportion of the phosphoric acid, chromic acid, and hydrofluoric acid to the acidic treatment liquid, for example, a concentration of the phosphoric acid may be in a range of 10% by mass or more and 11% by mass or less, a concentration of the chromic acid may be in a range of 3% by mass or more and 4% by mass or less, and a concentration of the hydrofluoric acid may be in a range of 0.5% by mass or more and 2% by mass or less, and a concentration of all of these acids may be in a range of 13.5% by mass or more and 18% by mass or less. A treatment temperature is, for example, preferably 42° C. or higher and 48° C. or lower. A film thickness of the coating film is, for example, preferably 0.3 μm or more and 15 μm or less.

The boehmite treatment is carried out, for example, by dipping the base material in pure water at 90° C. or higher and 100° C. or lower for 5 minutes to 60 minutes, or by bringing the base material into contact with heated steam at 90° C. or higher and 120° C. or lower for 5 minutes to 60 minutes.

A film thickness of the coating film is, for example, preferably 0.1 μm or more and 5 μm or less. The coating film may be further subjected to an anodizing treatment using an electrolytic solution having low film solubility, such as adipic acid, boric acid, a borate, a phosphate, a phthalate, a maleate, a benzoate, a tartrate, or a citrate.

### Interlayer

Although not shown in the drawings, an interlayer may be further provided between the undercoat layer and the photosensitive layer.

The interlayer is, for example, a layer containing a resin. Examples of the resin used for the interlayer include polymer compounds such as an acetal resin (for example, polyvinyl butyral or the like), a polyvinyl alcohol resin, a polyvinyl acetal resin, a casein resin, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenol-formaldehyde resin, and a melamine resin.

The interlayer may be a layer containing an organometallic compound. Examples of the organometallic compound used for the interlayer include organometallic compounds containing a metal atom such as zirconium, titanium, aluminum, manganese, and silicon.

The compounds used for the interlayer may be used alone or in a form of a mixture or a polycondensate of a plurality of compounds.

Among the above, for example, it is preferable that the interlayer is a layer containing an organometallic compound containing a zirconium atom or a silicon atom.

The formation of the interlayer is not particularly limited, and a known forming method is used. For example, a coating film of a coating solution for forming the interlayer, in which the above-described components are added to a solvent, is formed, and the coating film is dried and then heated as necessary.

Examples of the coating method of forming the interlayer include typical methods such as a dip coating method, a push-up coating method, a wire bar coating method, a spray coating method, a blade coating method, an air knife coating method, and a curtain coating method.

A film thickness of the interlayer is set to, for example, preferably in a range of 0.1 μm or more and 3 μm or less. The interlayer may be used as the undercoat layer.

### Charge Generation Layer

A charge generation layer is, for example, a layer containing a charge generation material and a binder resin. In addition, the charge generation layer may be a deposition layer of the charge generation material. For example, the deposition layer of the charge generation material is suitable in a case where an incoherent light source such as a light emitting diode (LED) and an organic electro-luminescence (EL) image array is used.

Examples of the charge generation material include an azo pigment such as a bisazo pigment and a trisazo pigment; a fused ring aromatic pigment such as dibromoanthanthrone; a perylene pigment; a pyrrolopyrrole pigment; a phthalocyanine pigment; zinc oxide; and trigonal selenium.

Among the above, for example, a metal phthalocyanine pigment or a metal-free phthalocyanine pigment is preferably used as the charge generation material, in order to deal with laser exposure in a near-infrared region. Specifically, for example, hydroxy gallium phthalocyanine, chlorogallium phthalocyanine, dichlorotin phthalocyanine, or titanyl phthalocyanine is more preferable.

On the other hand, for example, a fused ring aromatic pigment such as dibromoanthanthrone; a thioindigo-based pigment; a porphyrazine compound; zinc oxide; trigonal selenium; or a bisazo pigment is preferable as the charge generation material in order to deal with laser exposure in a near-ultraviolet region.

The above-described charge generation material may be used even in a case where a non-coherent light source such as an LED having a central wavelength of light emission in a range of 450 nm or more and 780 nm or less and an organic EL image array is used.

In a case where an n-type semiconductor such as a fused ring aromatic pigment, a perylene pigment, and an azo pigment is used as the charge generation material, a dark current is unlikely to be generated, and image defects referred to as black spots can be suppressed even in a case in which a thin film is used as the photosensitive layer.

The n-type is determined by the polarity of the flowing photocurrent using a typically used time-of-flight method, and a material in which electrons more easily flow as carriers than positive holes is determined as the n-type.

The binder resin used for the charge generation layer is selected from a wide range of insulating resins, and the binder resin may be selected from organic photoconductive polymers such as poly-N-vinylcarbazole, polyvinylanthracene, polyvinylpyrene, and polysilane.

Examples of the binder resin include a polyvinyl butyral resin, a polyarylate resin (polycondensate of bisphenols and aromatic divalent carboxylic acid, or the like), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin, and a polyvinylpyrrolidone resin. Here, the term “insulating” means that a volume resistivity is 10¹³Ω·cm or more.

The binder resins may be used alone or in a form of a mixture of two or more kinds thereof.

A blending ratio between the charge generation material and the binder resin is, for example, preferably in a range of 10:1 to 1:10 in terms of mass ratio.

The charge generation layer may also contain other known additives.

The formation of the charge generation layer is not particularly limited, and a known forming method is used. For example, a coating film of a coating solution for forming the charge generation layer, in which the above-described components are added to a solvent, is formed, and the coating film is dried and then heated as necessary. The charge generation layer may be formed by a vapor deposition of the charge generation material. For example, the formation of the charge generation layer by the vapor deposition is particularly preferable in a case where the fused ring aromatic pigment or the perylene pigment is used as the charge generation material.

Examples of the solvent for preparing the coating solution for forming the charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. The solvents are used alone or in a form of a mixture of two or more kinds thereof.

As a method of dispersing particles (for example, the charge generation material) in the coating solution for forming the charge generation layer, for example, a media disperser such as a ball mill, a vibration ball mill, an attritor, a sand mill, and a horizontal sand mill, or a medialess disperser such as a stirrer, an ultrasonic disperser, a roll mill, and a high-pressure homogenizer is used. Examples of the high-pressure homogenizer include a collision type high-pressure homogenizer in which a dispersion liquid is dispersed by a liquid-liquid collision or a liquid-wall collision in a high-pressure state, and a penetration type high-pressure homogenizer in which a dispersion liquid is dispersed by causing the dispersion liquid to penetrate through a micro-flow path in a high-pressure state.

During the dispersion, it is effective to set an average particle diameter of the charge generation material in the coating solution for forming the charge generation layer to 0.5 μm or less, for example, preferably 0.3 μm or less and more preferably 0.15 μm or less.

Examples of the method of coating the undercoat layer (or the interlayer) with the coating solution for forming the charge generation layer include typical methods such as a blade coating method, a wire bar coating method, a spray coating method, a dip coating method, a bead coating method, an air knife coating method, and a curtain coating method.

A film thickness of the charge generation layer is set to, for example, preferably in a range of 0.1 μm or more and 5.0 μm or less and more preferably in a range of 0.2 μm or more and 2.0 μm or less.

### Charge Transport Layer

A charge transport layer is, for example, a layer containing a charge transport material and a binder resin. The charge transport layer may be a layer containing a polymer charge transport material.

Examples of the charge transport material include a quinone-based compound such as p-benzoquinone, chloranil, bromanil, and anthraquinone; a tetracyanoquinodimethane-based compound; a fluorenone compound such as 2,4,7-trinitrofluorenone; a xanthone-based compound; a benzophenone-based compound; a cyanovinyl-based compound; and an electron-transporting compound such as an ethylene-based compound. Examples of the charge transport material also include a positive hole-transporting compound such as a triarylamine-based compound, a benzidine-based compound, an arylalkane-based compound, an aryl-substituted ethylene-based compound, a stilbene-based compound, an anthracene-based compound, and a hydrazone-based compound. The charge transport materials may be used alone or in combination of two or more kinds thereof, but are not limited thereto.

From the viewpoint of charge mobility, for example, a triarylamine derivative represented by Structural Formula (a-1) or a benzidine derivative represented by Structural Formula (a-2) is preferable as the charge transport material.

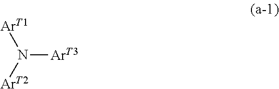

In Structural Formula (a-1), Ar^{T1}, Ar^{T2}, and Ar^{T3} each independently represent a substituted or unsubstituted aryl group, —C₆H₄—C(R^{T4})—C(R^{T5})(R^{T6}), or —C₆H₄—CH═CH—CH═C(R¹⁷)(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituent of each group described above include a halogen atom, an alkyl group having 1 or more and 5 or less carbon atoms, and an alkoxy group having 1 or more and 5 or less carbon atoms. In addition, examples of the substituent of each group described above also include a substituted amino group substituted with an alkyl group having 1 or more and 3 or less carbon atoms.

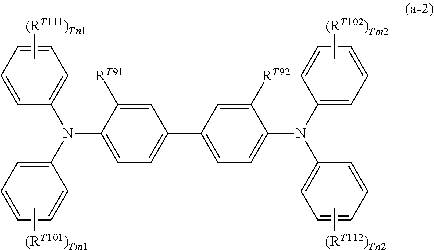

In Structural Formula (a-2), R^{T91} and R^{T92} each independently represent a hydrogen atom, a halogen atom, an alkyl group having 1 or more and 5 or less carbon atoms, or an alkoxy group having 1 or more and 5 or less carbon atoms. R^{T101}, R^{T102}, R^{T111}, and R^{T112} each independently represent a halogen atom, an alkyl group having 1 or more and 5 or less carbon atoms, an alkoxy group having 1 or more and 5 or less carbon atoms, an amino group substituted with an alkyl group having 1 or more and 2 or less carbon atoms, a substituted or unsubstituted aryl group, —C(R^{T12})—C(R^{T13})(R^{T14}), or —CH—CH—CH═C(R^{T15})(R^{T16}), in which R^{T12}, R^{T13}, R^{T14}, R^{T15}, and R^{T16} each independently represent a hydrogen atom, a substituted or unsubstituted alkyl group, or a substituted or unsubstituted aryl group. Tm1, Tm2, Tn1, and Tn2 each independently represent an integer of 0 or more and 2 or less.

Examples of the substituent of each group described above include a halogen atom, an alkyl group having 1 or more and 5 or less carbon atoms, and an alkoxy group having 1 or more and 5 or less carbon atoms. In addition, examples of the substituent of each group described above also include a substituted amino group substituted with an alkyl group having 1 or more and 3 or less carbon atoms.

Here, among the triarylamine derivative represented by Structural Formula (a-1) and the benzidine derivative represented by Structural Formula (a-2), for example, a triarylamine derivative having “—C₆H₄—CH═CH—CH═C (R^{T7})(R^{T8})” or a benzidine derivative having “—CH═CH—CH═C (R^{T15})(R^{T16})” is particularly preferable from the viewpoint of the charge mobility.

As the polymer charge transport material, known materials having charge transport properties, such as poly-N-vinylcarbazole and polysilane, are used. In particular, for example, a polyester-based polymer charge transport material is particularly preferable. The polymer charge transport material may be used alone or in combination of the binder resin.

Examples of the binder resin used for the charge transport layer include a polycarbonate resin, a polyester resin, a polyarylate resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-vinylcarbazole, and polysilane. Among the above, for example, a polycarbonate resin or a polyarylate resin is preferable as the binder resin. The binder resins may be used alone or in combination of two or more kinds thereof.

A blending ratio between the charge transport material and the binder resin is, for example, preferably 10:1 to 1:5 in terms of mass ratio.

The charge transport layer may also contain other known additives.

The formation of the charge transport layer is not particularly limited, and a known forming method is used. For example, a coating film of a coating solution for forming the charge transport layer, in which the above-described components are added to a solvent, is formed, and the coating film is dried and then heated as necessary.

Examples of the solvent for preparing the coating solution for forming the charge transport layer include typical organic solvents, for example, aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. The solvents are used alone or in a form of a mixture of two or more kinds thereof.

Examples of the coating method of coating the charge generation layer with the coating solution for forming the charge transport layer include typical methods such as a blade coating method, a wire bar coating method, a spray coating method, a dip coating method, a bead coating method, an air knife coating method, and a curtain coating method.

A film thickness of the charge transport layer is set to, for example, preferably in a range of 5 μm or more and 50 μm or less and more preferably in a range of 10 μm or more and 30 μm or less.

### Protective Layer

A protective layer is provided on the photosensitive layer as necessary. The protective layer is provided, for example, for the purpose of preventing a chemical change in the photosensitive layer during charging and further improving a mechanical strength of the photosensitive layer.

Therefore, for example, a layer formed of a cured film (crosslinked film) may be applied to the protective layer. Examples of the layer include layers described in the items 1) and 2) below.
1) A layer formed of a cured film with a composition containing a reactive group-containing charge transport material that has a reactive group and a charge-transporting skeleton in the same molecule (that is, a layer containing a polymer or a crosslinked body of the reactive group-containing charge transport material)
2) A layer formed of a cured film with a composition containing a non-reactive charge transport material and a reactive group-containing non-charge transport material that has a reactive group and does not have a charge-transporting skeleton (that is, a layer containing the non-reactive charge transport material, and a polymer or a crosslinked body of the reactive group-containing non-charge transport material)

Examples of the reactive group of the reactive group-containing charge transport material include known reactive groups such as a chain polymerizable group, an epoxy group, —OH, —OR [here, R represents an alkyl group], —NH₂, —SH, —COOH, and —SiR^{Q1}_{3-Qn}(OR^{Q2})_{Qn} [here, R^{Q1} represents a hydrogen atom, an alkyl group, or a substituted or unsubstituted aryl group, R^{Q2} represents a hydrogen atom, an alkyl group, or a trialkylsilyl group, and Qn represents an integer of 1 to 3].

The chain polymerizable group is not particularly limited as long as the group is a functional group capable of radical polymerization, and is, for example, a functional group having a group containing at least carbon double bond. Specific examples thereof include a vinyl group, a vinyl ether group, a vinyl thioether group, a styryl group (vinylphenyl group), an acryloyl group, a methacryloyl group, and a group containing at least one selected from derivatives thereof. Among the above, from the viewpoint that reactivity is excellent, for example, a vinyl group, a styryl group (vinylphenyl group), an acryloyl group, a methacryloyl group, or a group containing at least one selected from derivatives thereof is preferable as the chain polymerizable group.

The charge-transporting skeleton of the reactive group-containing charge transport material is not particularly limited as long as the skeleton is a known structure in the electrophotographic photoreceptor, and examples thereof include a structure conjugated with a nitrogen atom, which is a skeleton derived from a nitrogen-containing positive hole-transporting compound such as a triarylamine-based compound, a benzidine-based compound, and a hydrazone-based compound. Among the above, for example, a triarylamine skeleton is preferable.

The reactive group-containing charge transport material having the reactive group and the charge-transporting skeleton, the non-reactive charge transport material, and the reactive group-containing non-charge transport material may be selected from known materials.

The protective layer may also contain other known additives.

The formation of the protective layer is not particularly limited, and a known forming method is used. For example, a coating film of a coating solution for forming the protective layer, in which the above-described components are added to a solvent, is formed, and the coating film is dried and then subjected to a curing treatment such as heating as necessary.

Examples of the solvent for preparing the coating solution for forming the protective layer include an aromatic solvent such as toluene and xylene; a ketone-based solvent such as methyl ethyl ketone, methyl isobutyl ketone, and cyclohexanone; an ester-based solvent such as ethyl acetate and butyl acetate; an ether-based solvent such as tetrahydrofuran and dioxane; a cellosolve-based solvent such as ethylene glycol monomethyl ether; and an alcohol-based solvent such as isopropyl alcohol and butanol. The solvents are used alone or in a form of a mixture of two or more kinds thereof.

The coating solution for forming the protective layer may be a solvent-less coating solution.

Examples of the method of coating the photosensitive layer (for example, the charge transport layer) with the coating solution for forming the protective layer include typical methods such as a dip coating method, a push-up coating method, a wire bar coating method, a spray coating method, a blade coating method, an air knife coating method, and a curtain coating method.

A film thickness of the protective layer is set to, for example, preferably in a range of 1 μm or more and 20 μm or less and more preferably in a range of 2 μm or more and 10 μm or less.

### Image Forming Apparatus (and Process Cartridge)

The image forming apparatus according to the present exemplary embodiment includes the electrophotographic photoreceptor, a charging device that charges a surface of the electrophotographic photoreceptor, an electrostatic latent image forming device that forms an electrostatic latent image on the charged surface of the electrophotographic photoreceptor, a developing device that develops the electrostatic latent image formed on the surface of the electrophotographic photoreceptor with a developer containing a toner to form a toner image, and a transfer device that transfers the toner image to a surface of a recording medium. The above-described electrophotographic photoreceptor according to the present exemplary embodiment is adopted as the electrophotographic photoreceptor.

As the image forming apparatus according to the present exemplary embodiment, a known image forming apparatus such as an apparatus including a fixing device that fixes the toner image transferred to the surface of a recording medium; a direct transfer-type apparatus that transfers the toner image formed on the surface of the electrophotographic photoreceptor directly to the recording medium; an intermediate transfer-type apparatus that primarily transfers the toner image formed on the surface of the electrophotographic photoreceptor to a surface of an intermediate transfer member and secondarily transfers the toner image transferred to the surface of the intermediate transfer member to the surface of the recording medium; an apparatus including a cleaning device that cleans the surface of the electrophotographic photoreceptor after the transfer of the toner image and before the charging; an apparatus including a charge erasing device that erases the charges on the surface of the electrophotographic photoreceptor by applying the charge erasing light after the transfer of the toner image and before the charging; or an apparatus including an electrophotographic photoreceptor heating member for increasing the temperature of the electrophotographic photoreceptor and decreasing the relative temperature is adopted.

In a case of the intermediate transfer-type apparatus, the transfer device has a configuration including an intermediate transfer member with surface on which the toner image will be transferred, a primary transfer device that performs primary transfer to transfer the toner image formed on the surface of the electrophotographic photoreceptor to the surface of the intermediate transfer member, and a secondary transfer device that performs secondary transfer to transfer the toner image transferred to the surface of the intermediate transfer member to the surface of a recording medium.

The image forming apparatus according to the present exemplary embodiment may be any of a dry development-type image forming apparatus or a wet development-type (development type using a liquid developer) image forming apparatus.

In the image forming apparatus according to the present exemplary embodiment, for example, a portion including the electrophotographic photoreceptor may have a cartridge structure (process cartridge) that is attachable to and detachable from the image forming apparatus. As the process cartridge, for example, a process cartridge including the electrophotographic photoreceptor according to the present exemplary embodiment is preferably used. The process cartridge may include, for example, at least one selected from the group consisting of a charging device, an electrostatic latent image forming device, a developing device, and a transfer device, in addition to the electrophotographic photoreceptor.

An example of the image forming apparatus according to the present exemplary embodiment will be shown below, but the present invention is not limited thereto. Hereinafter, among the parts shown in the drawing, main parts will be described, and others will not be described.

FIG. 2 is a view schematically showing a configuration of an example of the image forming apparatus according to the present exemplary embodiment.

As shown in FIG. 2, an image forming apparatus 100 according to the present exemplary embodiment includes a process cartridge 300 including an electrophotographic photoreceptor 7, an exposure device 9 (an example of the electrostatic latent image forming device), a transfer device 40 (primary transfer device), and an intermediate transfer member 50. In the image forming apparatus 100, the exposure device 9 is disposed at a position that can be exposed to the electrophotographic photoreceptor 7 from an opening portion of the process cartridge 300; the transfer device 40 is disposed at a position that faces the electrophotographic photoreceptor 7 through the intermediate transfer member 50; and the intermediate transfer member 50 is disposed such that a part of the intermediate transfer member 50 is in contact with the electrophotographic photoreceptor 7. Although not shown, the image forming apparatus also includes a secondary transfer device that transfers the toner image transferred to the intermediate transfer member 50 to a recording medium (for example, paper). The intermediate transfer member 50, the transfer device 40 (primary transfer device), and the secondary transfer device (not shown) correspond to an example of the transfer device.

The process cartridge 300 in FIG. 2 integrally supports the electrophotographic photoreceptor 7, a charging device 8 (an example of the charging device), a developing device 11 (an example of the developing device), and a cleaning device 13 (an example of the cleaning device) in a housing. The cleaning device 13 has a cleaning blade (an example of a cleaning member) 131, and the cleaning blade 131 is disposed to come into contact with the surface of the electrophotographic photoreceptor 7. The cleaning member may be a conductive or insulating fibrous member instead of the aspect of the cleaning blade 131, and may be used alone or in combination with the cleaning blade 131.

FIG. 2 shows an example of an image forming apparatus including a fibrous member 132 (roll shape) that supplies a lubricant 14 to the surface of the electrophotographic photoreceptor 7 and a fibrous member 133 (flat brush shape) that assists the cleaning, but these are disposed as necessary.

Hereinafter, each configuration of the image forming apparatus according to the present exemplary embodiment will be described.

### Charging Device

As the charging device 8, for example, a contact-type charger formed of a conductive or semi-conductive charging roller, a charging brush, a charging film, a charging rubber blade, a charging tube, or the like is used. In addition, a known charger such as a non-contact type roller charger, and a scorotoron charger or a corotron charger using corona discharge is also used.

### Exposure Device

Examples of the exposure device 9 include an optical system device that exposes the surface of the electrophotographic photoreceptor 7 to light such as a semiconductor laser beam, LED light, and liquid crystal shutter light in a predetermined image pattern. A wavelength of the light source is within the spectral sensitivity region of the electrophotographic photoreceptor. As a wavelength of a semiconductor laser, near infrared laser, which has an oscillation wavelength in the vicinity of 780 nm, is mostly used. However, the wavelength is not limited thereto, and a laser having an oscillation wavelength of an approximately 600 nm level or a laser having an oscillation wavelength of 400 nm or more and 450 nm or less as a blue laser may also be used. In addition, a surface emission-type laser light source capable of outputting a multi-beam is also effective for forming a color image.

### Developing Device

Examples of the developing device 11 include a typical developing device that performs development in contact or non-contact with the developer. The developing device 11 is not particularly limited as long as the device has the above-described functions, and is selected depending on the purpose thereof. Examples thereof include known developing machines having a function of attaching a one-component developer or a two-component developer to the electrophotographic photoreceptor 7 using a brush, a roller, or the like. Among the above, for example, a developing roller in which a developer is retained on a surface is preferably used.

The developer used in the developing device 11 may be a one-component developer containing only a toner or a two-component developer containing a toner and a carrier. In addition, the developer may be magnetic or non-magnetic. Known developers are employed as the developer.

### Cleaning Device

As the cleaning device 13, a cleaning blade-type device including the cleaning blade 131 is used.

In addition to the cleaning blade-type device, a fur brush cleaning-type device or a simultaneous development cleaning-type device may be adopted.

### Transfer Device

Examples of the transfer device 40 include a known transfer charger such as a contact type transfer charger using a belt, a roller, a film, a rubber blade, or the like, and a scorotron transfer charger or a corotron transfer charger using corona discharge.

### Intermediate Transfer Member

As the intermediate transfer member 50, a semi-conductive belt-like intermediate transfer member (intermediate transfer belt) containing polyimide, polyamide-imide, polycarbonate, polyarylate, polyester, rubber, or the like is used. In addition, as the form of the intermediate transfer member, a drum-like intermediate transfer member may be used in addition to the belt-like intermediate transfer member.

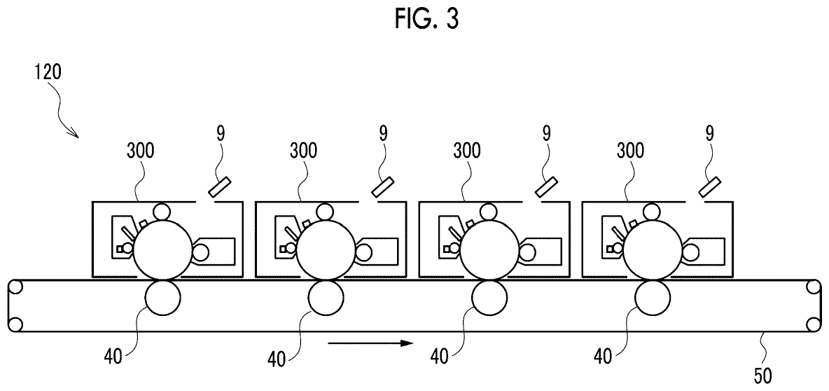

FIG. 3 is a view schematically showing a configuration of another example of the image forming apparatus according to the present exemplary embodiment.

An image forming apparatus 120 shown in FIG. 3 is a tandem type multicolor image forming apparatus in which four process cartridges 300 are mounted. The image forming apparatus 120 is formed such that the four process cartridges 300 are arranged in parallel on the intermediate transfer member 50, and one electrophotographic photoreceptor is used for each color. The image forming apparatus 120 has the same configuration as the image forming apparatus 100, except that the image forming apparatus 120 is of a tandem type.

### EXAMPLES

Hereinafter, exemplary embodiments of the present invention will be specifically described based on examples. However, the exemplary embodiments of the present invention are not limited to the examples.

In the following description, unless otherwise specified, “parts” and “%” are based on mass.

In the following description, the synthesis, the production, the treatment, the measurement, and the like are carried out at room temperature (25° C.±3° C.), unless otherwise specified.

### Preparation of Electron Transport Material

The following electron transport materials are prepared.

### Production of Electron Transport Material (1)

6.4 parts of the above-described electron transport material (P-1) having a crystal type of a β type (CCDC196997), 72 parts of zirconia beads having a diameter of 0.3 mm, and 1.0 part of sodium chloride are charged into a container made of zirconia, and pulverized at a rotation speed of 500 rpm for 2 hours using a planetary mill device (manufactured by Fritsch Japan Co., Ltd: P-7 classic line). After the pulverization, the pigment particles are separated by filtration while the zirconia beads are washed with 500 ml of distilled water. The obtained aqueous dispersion liquid of the pigment particles is centrifuged, and the supernatant water is removed by decantation to isolate the pigment. The isolated pigment is repeatedly washed with water until the electrical conductivity is 10 μS/cm or less, and then dried in a freeze dryer for 48 hr to obtain an electron transport material (1).

### Production of Electron Transport Material (2)

The same procedure is carried out as in the production of the electron transport material (1), except that the material used is changed to a material (crystal structure: COD8100240) shown below.

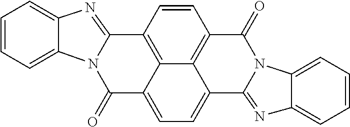 [SMILES: O=c1c2ccc3c4c(ccc(c24)c2nc4ccccc4n12)c(=O)n1c2ccccc2nc31]

### Production of Electron Transport Material (3)

The same procedure is carried out as in the production of the electron transport material (1), except that the material used is changed to a material (crystal structure: CCDC798609) shown below.

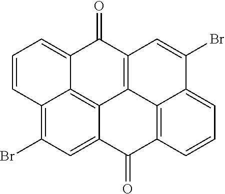 [SMILES: O=c1c2cc(Br)c3cccc4c(=O)c5cc(Br)c6cccc1c6c5-c2c34]

### Production of Electron Transport Material (4)

The same procedure is carried out as in the production of the electron transport material (1), except that the material used is changed to a material (crystal structure: COD2219436) shown below.

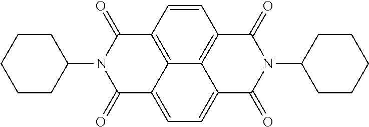 [SMILES: O=C1c2ccc3c4c(ccc(c24)C(=O)N1C1CCCCC1)C(=O)N(C1CCCCC1)C3=O]

### Preparation of Undercoat Layer

### Production of Undercoat Layer (1)

A mixed solution is obtained by mixing 70 parts of the electron transport material with the type shown in Table 1, 13.5 parts of a curing agent (blocked isocyanate, SUMIDUR 3175, manufactured by Sumitomo Bayer Urethane Co., Ltd.), 15 parts of a butyral resin (S-LEC BM-1, manufactured by Sekisui Chemical Co., Ltd.), and 85 parts of methyl ethyl ketone. 38 parts of the mixed solution and 25 parts of methyl ethyl ketone are mixed and dispersed for 3 hours in a sand mill using glass beads having a diameter of 1 mmφ, thereby obtaining a dispersion liquid. 0.005 parts of dioctyltin dilaurate as a catalyst is added to the obtained dispersion liquid to obtain a coating solution 1 for forming an undercoat layer.

The coating solution 1 for an undercoat layer is applied onto a cylindrical aluminum base material by a dip coating method, and dried and cured at 160° C. for 30 minutes to form a coating film having an average thickness of 9.6 μm.

Next, 40 parts of a nylon resin (manufactured by Toray Industries, Inc., Amilan (registered trademark) CM8000) is dissolved in 600 parts of methanol to prepare a coating solution 2 for an undercoat layer; and the coating solution 2 for an undercoat layer is applied onto the cured film formed of the coating solution 1 for an undercoat layer, and dried and cured at 140° C. for 30 minutes to form a coating film having an average thickness of 0.4 μm and consisting of a nylon resin.

In this manner, an undercoat layer (1) having an average thickness shown in Table 1 is obtained.

### Undercoat Layer (2)

An undercoat layer having an average thickness shown in Table 1 is produced by the same procedure, except that, in the production of the undercoat layer (1), the type of the nylon resin in the coating solution 2 for an undercoat layer is changed to Amilan (registered trademark) CM4000 manufactured by Toray Industries, Inc.

### Undercoat Layer (3)

A mixed solution is obtained by mixing 59 parts of the electron transport material with the type shown in Table 1, 13.5 parts of a curing agent (blocked isocyanate, SUMIDUR 3175, manufactured by Sumitomo Bayer Urethane Co., Ltd.; solid content: 75%), 15 parts of a butyral resin (S-LEC BM-1, manufactured by Sekisui Chemical Co., Ltd.), and 85 parts of methyl ethyl ketone. 38 parts of the mixed solution and 25 parts of methyl ethyl ketone are mixed and dispersed for 3 hours in a sand mill using glass beads having a diameter of 1 mmφ, thereby obtaining a dispersion liquid. 0.005 parts of dioctyltin dilaurate as a catalyst is added to the obtained dispersion liquid to obtain a coating solution 1 for forming an undercoat layer. The coating solution for an undercoat layer is applied onto a cylindrical aluminum base material by a dip coating method, and dried and cured at 160° C. for 30 minutes to form a coating film having an average thickness of 9.6 μm.

Thereafter, a coating solution 2 for an undercoat layer, in which the amount of the electron transport material is changed to 25 parts in the production step of the coating solution 1 for an undercoat layer, is produced. Next, the coating solution 2 for an undercoat layer is applied onto the coating film produced using the coating solution 1 for an undercoat layer, and dried and cured at 160° C. for 30 minutes to form a coating film having an average thickness of 0.4 μm and consisting of a polyurethane resin.

In this manner, an undercoat layer having an average thickness shown in Table 1 is obtained.

### Undercoat Layers (4) to (20)

In the production of the undercoat layer (3), the undercoat layer is adjusted so that X1, X2, Y1, Y2, X1/X2, and Y1/Y2 are values shown in Table 1 by changing and adjusting the types and formulations of the electron transport materials of the coating solution 1 for an undercoat layer and the coating solution 2 for an undercoat layer.

However, in Example 11, a film thickness of the coating solution 1 for an undercoat layer is set to 16.3 μm, a film thickness of the coating solution 2 for an undercoat layer is set to 0.7 μm, and an undercoat layer having an average thickness shown in Table 1 is obtained.

In addition, in Example 12, a film thickness of the coating solution 1 for an undercoat layer is set to 0.6 μm, a film thickness of the coating solution 2 for an undercoat layer is set to 0.4 μm, and an undercoat layer having an average thickness shown in Table 1 is obtained.

### Undercoat Layer (C1)

A mixed solution is obtained by mixing 59 parts of the electron transport material with the type shown in Table 1, 13.5 parts of a curing agent (blocked isocyanate, SUMIDUR 3175, manufactured by Sumitomo Bayer Urethane Co., Ltd.; solid content: 75%), 15 parts of a butyral resin (S-LEC BM-1, manufactured by Sekisui Chemical Co., Ltd.), and 85 parts of methyl ethyl ketone. 38 parts of the mixed solution and 25 parts of methyl ethyl ketone are mixed and dispersed for 3 hours in a sand mill using glass beads having a diameter of 1 mmφ, thereby obtaining a dispersion liquid. 0.005 parts of dioctyltin dilaurate as a catalyst is added to the obtained dispersion liquid to obtain a coating solution 1 for forming an undercoat layer. The coating solution is applied onto a cylindrical aluminum base material by a dip coating method, and dried and cured at 160° C. for 30 minutes.

In this manner, an undercoat layer having an average thickness shown in Table 1 is obtained.

### Undercoat Layers (C2) and (C3)

Each undercoat layer is obtained in the same specification as in the undercoat layer (1), except that the type of the electron transport material in the undercoat layer (C1) is set as the type shown in Table 1.

X1, X2, the ratio (X1/X2), Y1, Y2, the ratio (Y1/Y2), and the type, particle diameter, and aspect ratio of the electron transport material in each undercoat layer are shown in Table 1.

In Table 1, “X1” indicates the content X1(% by mass) of the electron transport material in the region within 4% in the thickness direction of the undercoat layer from the interface between the undercoat layer and the charge generation layer.

In Table 1, “X2” indicates the content X2(% by mass) of the electron transport material in the region exceeding 4% in the thickness direction of the undercoat layer from the interface between the undercoat layer and the charge generation layer.

In Table 1, “Y1” indicates the area ratio Y1(%) of the electron transport material in the region within 4% in the thickness direction of the undercoat layer from the interface between the undercoat layer and the charge generation layer, in the cross section in the thickness direction.

In Table 1, “Y2” indicates the area ratio Y2(%) of the electron transport material in the region exceeding 4% in the thickness direction of the undercoat layer from the interface between the undercoat layer and the charge generation layer, in the cross section in the thickness direction.

In Table 1, “Average thickness” indicates the average thickness of the entire undercoat layer.

### Examples 1 to 20 and Comparative Examples C1 to C3

### Formation of Charge Generation Layer

A mixture of 15 parts by mass of hydroxygallium phthalocyanine having diffraction peaks at positions where Bragg angles (20+) 0.2° in an X-ray diffraction spectrum using Cukα characteristic X-rays are at least 7.3°, 16.0°, 24.9°, and 28.0° as a charge generation material, 10 parts by mass of vinyl chloride-vinyl acetate copolymer resin (VMCH, manufactured by Nippon Unicar Company Limited) as a binder resin, and 200 parts by mass of n-butyl acetate is stirred and dispersed in a sand mill for 4 hours using glass beads having a diameter of 1 mmφ. 175 parts by mass of n-butyl acetate and 180 parts by mass of methyl ethyl ketone are added to the obtained dispersion liquid, and the mixture is stirred, thereby obtaining a coating solution for forming a charge generation layer. The outer peripheral surface of the undercoat layer with the type shown in Table 1 is dipped and coated with the coating solution for forming a charge generation layer, and the solution is dried at 150° C. for 15 minutes, thereby forming a charge generation layer having a film thickness of 0.2 μm.

### Formation of Charge Transport Layer

38 parts by mass of the charge transport material (HT-1) shown below, 10 parts by mass of the charge transport material (HT-2) shown below, 52 parts by mass of the polycarbonate resin (A) (viscosity-average molecular weight: 46,000; numerical values in the formula represent molar ratios) shown below, and 0.3 part by mass of a fluorine-containing graft polymer (GF-500, manufactured by Toagosei Co., Ltd.) as a dispersion assistant are added to and dissolved in 800 parts by mass of tetrahydrofuran, 8 parts by mass of ethylene tetrafluoride resin (LUBRON L5, manufactured by Daikin Industries, Ltd., average particle diameter of 300 nm) is added thereto and dispersed at 5500 rpm for 2 hours using a homogenizer (ULTRA-TURRAX, manufactured by IKA Japan K.K.), thereby obtaining a coating solution for forming a charge transport layer. The charge generation layer is coated with the coating solution, and the solution is dried at 140° C. for 40 minutes, thereby forming a charge transport layer having a film thickness of 30 μm. The charge transport layer is used as an electrophotographic photoreceptor.

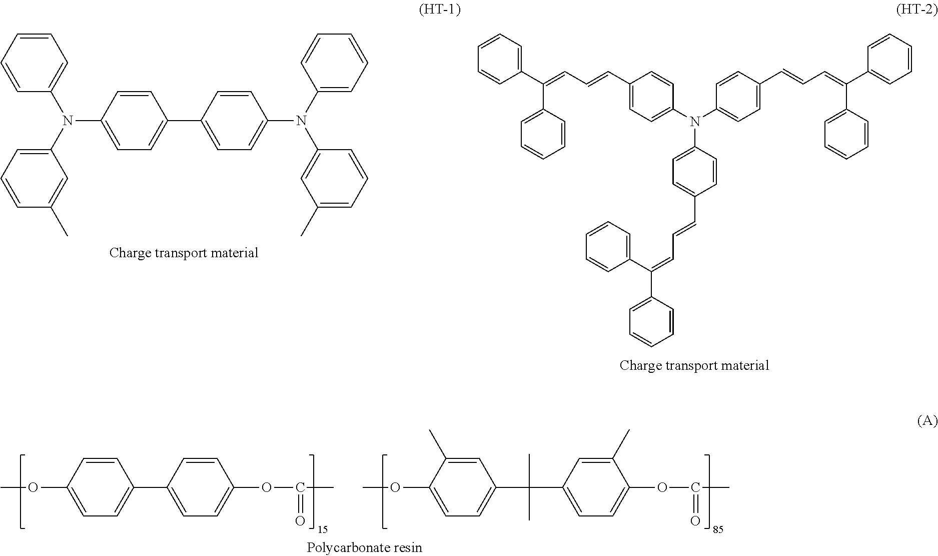

### Evaluation of Charge Retention Property in Long-Term Operation in High-Temperature and High-Humidity Environment

The electrophotographic photoreceptor of each example is mounted on a laser printer-modified scanner (XP-15 modified machine) manufactured by FUJIFILM Business Innovation Corp. In an environment of a temperature of 30° C. and a relative humidity of 85% RH, the electrophotographic photoreceptor is charged with a scorotron charger at a grid application voltage of −700 V, and an initial charging potential M1 is measured. Next, a cycle of charging the electrophotographic photoreceptor with the scototron charger at a grid application voltage of −800 V in an environment of a temperature of 30° C. and a relative humidity of 85% RH, and then exposure at 4 mJ/cm² is repeated 100,000 times, and a potential M2 after 100 msec from the charging in the last cycle is measured. A difference ΔM=(M1−M2) between the obtained initial potential M1 and the potential M2 after long-term use is obtained, and charge retention property is evaluated based on the following standard. The allowable range is A to C.

### Evaluation Standard

A: measured potential difference ΔM is less than 15 V.
B: measured potential difference ΔM is 15 V or more and less than 25 V.
C: measured potential difference ΔM is 25 V or more and less than 35 V.
D: measured potential difference ΔM is 35 V or more.

### Evaluation of Initial Sensitivity

The electrophotographic photoreceptor of each example is mounted on a laser printer-modified scanner (XP-15 modified machine) manufactured by FUJIFILM Business Innovation Corp. In an environment of a temperature of 20° C. and a relative humidity of 40% RH, the electrophotographic photoreceptor is charged with a scorotron charger at a grid application voltage of −700 V, exposed at 4 mJ/cm² using a semiconductor laser having a wavelength of 780 nm, and then a potential M3 is measured at a position corresponding to 70 msec after the charging. Initial sensitivity of the obtained potential M3 is evaluated according to the following standard. The allowable range is A to C.

### Evaluation Standard

A: measured potential M3 is more than-50 V.
B: measured potential M3 is-50 V or less and more than-57 V.
C: measured potential M3 is-57 V or less and more than-65 V.
D: measured potential M3 is-65 V or less.

TABLE 1

| | Undercoat layer | | | | | | | | | | | Evaluation | |
|---|---|---|---|---|---|---|---|---|---|---|---|---|---|
| | | Electron transport | | | | | | | | | | of charge | |
| | | material | | | | | | Mass | | | Area | retention | |
| | | | Primary | | Average | X1 | X2 | ratio | | | ratio | property in | Evaluation |
| | | | particle | Aspect | thickness | % by | % by | (X1/X2) | Y1 | Y2 | (Y1/Y2) | long-term | of initial |
| | No. | Type | size μm | ratio | μm | mass | mass | % | % | % | % | operation | sensitivity |
| Example 1 | 1 | 1 | 59 | 1.9 | 10 | 0 | 70 | 0 | 0 | 73 | 0 | A | A |
| Example 2 | 2 | 1 | 59 | 1.9 | 10 | 0 | 70 | 0 | 0 | 73 | 0 | A | A |
| Example 3 | 3 | 1 | 59 | 1.9 | 10 | 50 | 70 | 71 | 55 | 73 | 76 | A | A |
| Example 4 | 4 | 1 | 59 | 1.9 | 10 | 53 | 70 | 76 | 58 | 73 | 80 | B | A |
| Example 5 | 5 | 1 | 59 | 1.9 | 10 | 45 | 70 | 64 | 51 | 73 | 70 | A | B |
| Example 6 | 6 | 2 | 195 | 4.8 | 10 | 50 | 70 | 71 | 60 | 74 | 81 | A | B |
| Example 7 | 7 | 3 | 85 | 2.4 | 10 | 50 | 70 | 71 | 52 | 70 | 74 | A | B |
| Example 8 | 8 | 4 | 54 | 2.7 | 10 | 50 | 70 | 71 | 60 | 76 | 78 | A | C |
| Example 9 | 9 | 3 | 85 | 2.4 | 10 | 55 | 70 | 79 | 56 | 70 | 81 | C | B |
| Example 10 | 10 | 4 | 54 | 2.7 | 10 | 53 | 70 | 76 | 62 | 76 | 82 | C | C |
| Example 11 | 11 | 1 | 59 | 1.9 | 17 | 50 | 70 | 71 | 55 | 73 | 76 | B | C |
| Example 12 | 12 | 1 | 59 | 1.9 | 1 | 50 | 70 | 71 | 55 | 73 | 76 | C | B |
| Example 13 | 13 | 1 | 59 | 1.9 | 10 | 56 | 76 | 74 | 61 | 78 | 78 | C | A |
| Example 14 | 14 | 1 | 59 | 1.9 | 10 | 40 | 70 | 57 | 47 | 73 | 64 | B | C |
| Example 15 | 15 | 1 | 59 | 1.9 | 10 | 50 | 82 | 61 | 55 | 83 | 66 | B | C |
| Example 16 | 16 | 1 | 59 | 1.9 | 10 | 42 | 58 | 72 | 48 | 62 | 78 | C | C |
| Example 17 | 17 | 4 | 54 | 2.7 | 10 | 55 | 75 | 73 | 64 | 80 | 80 | C | A |
| Example 18 | 18 | 3 | 85 | 2.4 | 10 | 42 | 70 | 60 | 45 | 70 | 64 | B | C |
| Example 19 | 19 | 4 | 54 | 2.7 | 10 | 55 | 77 | 71 | 64 | 82 | 78 | B | C |
| Example 20 | 20 | 3 | 85 | 2.4 | 10 | 45 | 59 | 76 | 47 | 60 | 79 | C | C |
| Comparative | C1 | 1 | 59 | 1.9 | 10 | 70 | 70 | 100 | 73 | 73 | 100 | D | A |
| Example C1 | | | | | | | | | | | | | |
| Comparative | C2 | 2 | 195 | 4.8 | 10 | 70 | 70 | 100 | 74 | 74 | 100 | D | B |
| Example C2 | | | | | | | | | | | | | |
| Comparative | C3 | 3 | 85 | 2.4 | 10 | 70 | 70 | 100 | 72 | 72 | 100 | D | B |
| Example C3 | | | | | | | | | | | | | |

As shown in Table 1, it is found that the electrophotographic photoreceptors of Examples have excellent charge retention property even in a case of long-term operation in a high-temperature and high-humidity environment, as compared with the electrophotographic photoreceptors of Comparative Examples.

The electrophotographic photoreceptor, the process cartridge, and the image forming apparatus according to the present disclosure include the following aspects.
(((1))) An electrophotographic photoreceptor comprising:
a conductive substrate;
an undercoat layer that is provided on the conductive substrate and contains an electron transport material and a binder resin;
a charge generation layer that is provided on the undercoat layer; and
a charge transport layer that is provided on the charge generation layer,
wherein, in the undercoat layer, a ratio (X1/X2) of a content X1(% by mass) of the electron transport material in a region within 4% in a thickness direction of the undercoat layer from an interface between the undercoat layer and the charge generation layer to a content X2(% by mass) of the electron transport material in a region exceeding 4% in the thickness direction of the undercoat layer from the interface between the undercoat layer and the charge generation layer is 0 or 78 or less.
(((2))) An electrophotographic photoreceptor comprising:
a conductive substrate;
an undercoat layer that is provided on the conductive substrate and contains an electron transport material and a binder resin;
a charge generation layer that is provided on the undercoat layer; and
a charge transport layer that is provided on the charge generation layer,
wherein, in a cross section in a thickness direction of the undercoat layer, a ratio (Y1/Y2) of an area ratio Y1(%) of the electron transport material in a region within 4% in the thickness direction of the undercoat layer from an interface between the undercoat layer and the charge generation layer to an area ratio Y2(%) of the electron transport material in a region exceeding 4% in the thickness direction of the undercoat layer from the interface between the undercoat layer and the charge generation layer is 0 or 81 or less.
(((3))) The electrophotographic photoreceptor according to (((1))) or (((2))),
wherein the electron transport material includes an acid anhydride having electron transport performance.
(((4))) The electrophotographic photoreceptor according to (((3))),
wherein the electron transport material includes a compound represented by Formula (P),

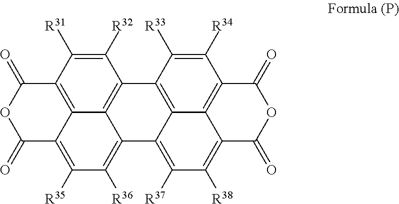

in Formula (P), R³¹, R³², R³³, R³⁴, R³⁵, R³⁶, R³⁷, and R³⁸ each independently represent a hydrogen atom, an alkyl group, an alkoxy group, an aralkyl group, an aryl group, an alkoxycarbonyl group, or a halogen atom.
(((5))) The electrophotographic photoreceptor according to any one of (((1))) to (((4))),
wherein an average thickness of the undercoat layer is 2 nm or more and 15 nm or less.
(((6))) The electrophotographic photoreceptor according to any one of (((1))) to (((5))),
wherein, in the undercoat layer, the content X1 of the electron transport material in the region within 4% in the thickness direction of the undercoat layer from the interface between the undercoat layer and the charge generation layer is 0% by mass or 55% by mass or less.
(((7))) The electrophotographic photoreceptor according to (((6))),
wherein, in the undercoat layer, the content X2 of the electron transport material in the region exceeding 4% in the thickness direction of the undercoat layer from the interface between the undercoat layer and the charge generation layer is 60% by mass or more or 80% by mass or less.
(((8))) The electrophotographic photoreceptor according to any one of (((1))) to (((7))),
wherein, in the cross section in the thickness direction of the undercoat layer, the area ratio Y1 of the electron transport material in the region within 4% in the thickness direction of the undercoat layer from the interface between the undercoat layer and the charge generation layer is 0% or 63% or less.
(((9))) The electrophotographic photoreceptor according to (((8))),
wherein, in the cross section in the thickness direction of the undercoat layer, the area ratio Y2 of the electron transport material in the region exceeding 4% in the thickness direction of the undercoat layer from the interface between the undercoat layer and the charge generation layer is 60% or more and 80% or less.
(((10))) A process cartridge comprising:
the electrophotographic photoreceptor according to any one of (((1))) to (((9))),
wherein the process cartridge is attachable to and detachable from an image forming apparatus.
(((11))) An image forming apparatus comprising:
the electrophotographic photoreceptor according to any one of (((1))) to (((9)));
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising:
a conductive substrate;
an undercoat layer that is provided on the conductive substrate and contains an electron transport material and a binder resin;
a charge generation layer that is provided on the undercoat layer; and
a charge transport layer that is provided on the charge generation layer,
wherein, in the undercoat layer, a ratio (X1/X2) of a content X1(% by mass) of the electron transport material in a region within 4% in a thickness direction of the undercoat layer from an interface between the undercoat layer and the charge generation layer to a content X2(% by mass) of the electron transport material in a region exceeding 4% in the thickness direction of the undercoat layer from the interface between the undercoat layer and the charge generation layer is 0 or 78 or less.

2. An electrophotographic photoreceptor comprising:
a conductive substrate;
an undercoat layer that is provided on the conductive substrate and contains an electron transport material and a binder resin;
a charge generation layer that is provided on the undercoat layer; and
a charge transport layer that is provided on the charge generation layer,
wherein, in a cross section in a thickness direction of the undercoat layer, a ratio (Y1/Y2) of an area ratio Y1(%) of the electron transport material in a region within 4% in the thickness direction of the undercoat layer from an interface between the undercoat layer and the charge generation layer to an area ratio Y2(%) of the electron transport material in a region exceeding 4% in the thickness direction of the undercoat layer from the interface between the undercoat layer and the charge generation layer is 0 or 81 or less.

3. The electrophotographic photoreceptor according to claim 1,
wherein the electron transport material includes an acid anhydride having electron transport performance.

4. The electrophotographic photoreceptor according to claim 2,
wherein the electron transport material includes an acid anhydride having electron transport performance.

5. The electrophotographic photoreceptor according to claim 3,
wherein the electron transport material includes a compound represented by Formula (P), 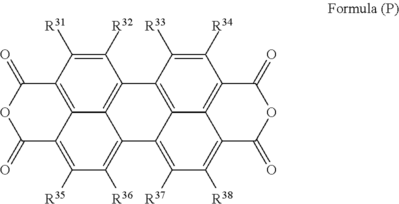
in Formula (P), R³¹, R³², R³³, R³⁴, R³⁵, R³⁶, R³⁷, and R³⁸ each independently represent a hydrogen atom, an alkyl group, an alkoxy group, an aralkyl group, an aryl group, an alkoxycarbonyl group, or a halogen atom.

6. The electrophotographic photoreceptor according to claim 4,
wherein the electron transport material includes a compound represented by Formula (P), 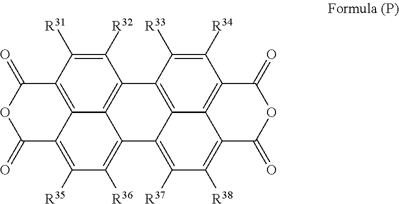
in Formula (P), R³¹, R³², R³³, R³⁴, R³⁵, R³⁶, R³⁷, and R³⁸ each independently represent a hydrogen atom, an alkyl group, an alkoxy group, an aralkyl group, an aryl group, an alkoxycarbonyl group, or a halogen atom.

7. The electrophotographic photoreceptor according to claim 1,
wherein an average thickness of the undercoat layer is 2 nm or more and 15 nm or less.

8. The electrophotographic photoreceptor according to claim 2,
wherein an average thickness of the undercoat layer is 2 nm or more and 15 nm or less.

9. The electrophotographic photoreceptor according to claim 1,
wherein, in the undercoat layer, the content X1 of the electron transport material in the region within 4% in the thickness direction of the undercoat layer from the interface between the undercoat layer and the charge generation layer is 0% by mass or 55% by mass or less.

10. The electrophotographic photoreceptor according to claim 2,
wherein, in the undercoat layer, the content X1 of the electron transport material in the region within 4% in the thickness direction of the undercoat layer from the interface between the undercoat layer and the charge generation layer is 0% by mass or 55% by mass or less.

11. The electrophotographic photoreceptor according to claim 9,
wherein, in the undercoat layer, the content X2 of the electron transport material in the region exceeding 4% in the thickness direction of the undercoat layer from the interface between the undercoat layer and the charge generation layer is 60% by mass or more or 80% by mass or less.

12. The electrophotographic photoreceptor according to claim 10,
wherein, in the undercoat layer, the content X2 of the electron transport material in the region exceeding 4% in the thickness direction of the undercoat layer from the interface between the undercoat layer and the charge generation layer is 60% by mass or more or 80% by mass or less.

13. The electrophotographic photoreceptor according to claim 1,
wherein, in the cross section in the thickness direction of the undercoat layer, the area ratio Y1 of the electron transport material in the region within 4% in the thickness direction of the undercoat layer from the interface between the undercoat layer and the charge generation layer is 0% or 63% or less.

14. The electrophotographic photoreceptor according to claim 2,
wherein, in the cross section in the thickness direction of the undercoat layer, the area ratio Y1 of the electron transport material in the region within 4% in the thickness direction of the undercoat layer from the interface between the undercoat layer and the charge generation layer is 0% or 63% or less.

15. The electrophotographic photoreceptor according to claim 13,
wherein, in the cross section in the thickness direction of the undercoat layer, the area ratio Y2 of the electron transport material in the region exceeding 4% in the thickness direction of the undercoat layer from the interface between the undercoat layer and the charge generation layer is 60% or more and 80% or less.

16. The electrophotographic photoreceptor according to claim 14,
wherein, in the cross section in the thickness direction of the undercoat layer, the area ratio Y2 of the electron transport material in the region exceeding 4% in the thickness direction of the undercoat layer from the interface between the undercoat layer and the charge generation layer is 60% or more and 80% or less.

17. A process cartridge comprising:
the electrophotographic photoreceptor according to claim 1,
wherein the process cartridge is attachable to and detachable from an image forming apparatus.

18. A process cartridge comprising:
the electrophotographic photoreceptor according to claim 2,
wherein the process cartridge is attachable to and detachable from an image forming apparatus.

19. An image forming apparatus comprising:
the electrophotographic photoreceptor according to claim 1;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

20. An image forming apparatus comprising:
the electrophotographic photoreceptor according to claim 2;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.
